(19) United States
(12) Patent Application Publication
(10) Pub. No.: US 2021/0045111 A1
(43) Pub. Date: Feb. 11, 2021

(54) METHOD AND DEVICE USED IN WIRELESS COMMUNICATION NODES

(71) Applicants: Xiaobo ZHANG, SHANGHAI (CN); Lin YANG, SHANGHAI (CN)

(72) Inventors: Xiaobo ZHANG, SHANGHAI (CN); Lin YANG, SHANGHAI (CN)

(73) Assignee: SHANGHAI LANGBO COMMUNICATION TECHNOLOGY COMPANY LIMITED, SHANGHAI (CN)

(21) Appl. No.: 17/035,923

(22) Filed: Sep. 29, 2020

Related U.S. Application Data
(63) Continuation of application No. PCT/CN2019/089288, filed on May 30, 2019.

(30) Foreign Application Priority Data
Jun. 25, 2018 (CN) 201810662243.X

(51) Int. Cl. H04W 72/04; H04L 1/00; H04W 4/40

(52) U.S. Cl. CPC H04W 72/0446; H04W 4/40; H04L 1/0009

(57) ABSTRACT

The present disclosure provides a method and a device in a node for wireless communications. A first node transmits a first radio signal on a first radio resource; herein, the first radio signal comprises a first signaling, the first signaling comprising first information; whether the first signaling comprises second information is related to the first information, and the first information in the first signaling indicates whether the first node is in coverage; or, whether the first signaling comprises second information is related to the first information, the first information in the first signaling indicates Q1 radio resource(s), and the first radio resource is one of the Q1 radio resource(s), Q1 being a positive integer. The flexible indication of present disclosure according to synchronization priority conditions on different radio resources, improving utilization efficiency of signalings and being easy to be forward compatible.

### CROSS REFERENCE TO RELATED APPLICATIONS

This application is a continuation of International Application No. PCT/CN2019/089288, filed May 30, 2019, claims the priority benefit of Chinese Patent Application No. 201810662243.X, filed on Jun. 25, 2018, the full disclosure of which is incorporated herein by reference.

### BACKGROUND

### Technical Field

The present disclosure relates to transmission methods and devices in wireless communication systems, and in particular to a multicarrier, multi-antenna and bandwidth related transmission scheme and device in wireless communications.

### Related Art

Application scenarios of future wireless communication systems are becoming increasingly diversified, and different application scenarios have different performance demands on systems. In order to meet different performance requirements of various application scenarios, the 3^{rd} Generation Partner Project (3GPP) Radio Access Network (RAN) #72 plenary session decided to conduct the study of New Radio (NR), or what is called fifth Generation (5G). The work Item (WI) of NR was approved at the 3GPP RAN #75 plenary session to standardize the NR.

In response to rapidly growing Vehicle-to-Everything (V2X) traffic, 3GPP has started standards setting and research work under the framework of NR. Currently, 3GPP has completed planning work targeting 5G V2X requirements and has included these requirements into standard TS22.886, where 3GPP identifies and defines 4 major Use Case Groups, covering cases of Vehicles Platooning, supporting Extended Sensors, Advanced Driving and Remote Driving.

### SUMMARY

To meet emerging traffic requirements, an NR V2X system is an updated version of the LTE V2X system, featuring higher throughput and reliability, lower latency, more distant communications with more precise positioning, and larger packet size and more various transmission period, as well as key technical features more compatible with the current 3GPP and non-3GPP techniques. Further, the NR V2X will be applied in a carrier aggregation and a higher-frequency section. At present, 3GPP has introduced characteristics of carrier aggregation and multi-Bandwidth-Part (BWP), and there is now a hot debate among members of 3GPP about 6 GHz-and-above Sidelink channel model, at the same time, an NR system will support more flexible uplink and downlink resources configuration, with symbol-level precision.

A determination of Sidelink transmission timing of the present LTE D2D/V2X depends on a synchronization priority of a radio signal received on Sidelink, and whether a synchronization source for transmitting the radio signal is in coverage influences a synchronization priority of the radio signal. In the case of a multicarrier, a multi-BWP or a multi-beam, when a radio signal received by a same User Equipment (UE) on one carrier, BWP or beam is in coverage, a radio signal received on another carrier, BWP or beam may not be in coverage. When a UE receives a radio signal on one carrier, BWP or beam, whether a reception timing of the radio signal can be used for determining a transmission timing for transmitting a radio signal on another carrier, BWP or beam.

In view of the above problem, the present disclosure provides a solution. It should be noted that the embodiments of a UE in the present disclosure and the characteristics of the embodiments may be applied to a base station if no conflict is incurred, and vice versa. The embodiments of the present disclosure and the characteristics of the embodiments may be mutually combined if no conflict is incurred. Furthermore, though originally targeted at multi-antenna-based communications, the present disclosure is also applicable to single-antenna communications. Besides, the present disclosure not only applies to high-frequency communications, but also to lower-frequency communications.

The following definitions given in the present disclosure can be used in all embodiments in the present disclosure and characteristics of the embodiments:

A first-type channel comprises at least one of a Broadcast Channel (BCH), a Physical Broadcast Channel (PBCH), a Physical Downlink Control Channel (PDCCH), a Physical Downlink Shared Channel (PDSCH), a Narrowband Physical Broadcast Channel (NPBCH), a Narrowband Physical Downlink Control Channel (NPDCCH), and a Narrowband Physical Downlink Shared Channel (NPDSCH).

A second-type channel comprises at least one of a Physical Random Access Channel (PRACH), a Physical Uplink Control Channel (PUCCH), a Physical Uplink Shared Channel (PUSCH), a Narrowband Physical Random Access Channel (NPRACH), a Narrowband Physical Uplink Shared Channel (NPUSCH), and a Short Physical Uplink Control Channel (SPUCCH).

A third-type channel comprises at least one of a Sidelink Broadcast Channel (SL-BCH), a Physical Sidelink Broadcast Channel (PSBCH), a Physical Sidelink Discovery Channel (PSDCH), a Physical Sidelink Control Channel (PSCCH), and a Physical Sidelink Shared Channel (PSSCH).

A first-type signal comprises at least one of a Primary Synchronization Signal (PSS), a Secondary Synchronization Signal (SSS), a Synchronization Signal/Physical Broadcast Channel (SSB), a Narrowband Primary Synchronization Signal (NPSS), a Narrowband Secondary Synchronization Signal (NSSS), a Reference Signal (RS), a Channel State Information-Reference Signal (CSI-RS), a Downlink Demodulation Reference Signal (Downlink Demodulation Reference Signal), a Discovery Signal (DS), a Narrowband Reference Signal (NRS), a Positioning Reference Signal (PRS), a Narrowband Positioning Reference Signal (NPRS), and a Phase-Tracking Reference Signal (PT-RS).

A second-type signal comprises at least one of a Preamble, an Uplink Demodulation Reference Signal (UL DMRS), a Sounding Reference Signal (SRS), and an Uplink Tracking Reference Signal (UL TRS).

A third-type signal comprises at least one of a Sidelink Synchronization Signal (SLSS), a Primary Sidelink Synchronization Signal (PSSS), a Secondary Sidelink Synchronization Signal (SSSS), a Sidelink Demodulation Reference Signal (SL DMRS), and a PSBCH Demodulation Reference Signal (PSBCH-DMRS).

In one embodiment, the third-type signal comprises a PSSS and an SSSS.

In one embodiment, the third-type signal comprises a PSSS, an SSSS and a PSBCH.

A first pre-processing comprises at least one of first-level scrambling, transport-block-level (TB-level) Cyclic Redundancy Check (CRC) Attachment, Channel Coding, Rate Matching, second-level scrambling, Modulation, Layer Mapping, Transform Precoding, Precoding, Mapping to Physical Resources, Baseband Signal Generation, and Modulation and Upconversion.

In one embodiment, the first precoding is sequentially first-level scrambling, TB-level CRC Attachment, Channel Coding, Rate Matching, second-level scrambling, Modulation, Layer Mapping, Transform Precoding, Precoding, Mapping to Physical Resources, Baseband Signal Generation, and Modulation and Upconversion.

A second preprocessing comprises at least one of TB-level CRC attachment, Code Block (CB) Segmentation, CB-level CRC attachment, channel coding, rate matching, CB Concatenation, scrambling, modulation, layer mapping, antenna port mapping, Mapping to Virtual Resource Blocks, Mapping from Virtual to Physical Resource Blocks (PRB), baseband signal generation, and modulation and Upconversion.

In one embodiment, the second preprocessing is sequentially TB-level CRC attachment, CB segmentation, CB-level CRC attachment, channel coding, rate matching, CB Concatenation, scrambling, modulation, layer mapping, antenna port mapping, Mapping to Virtual Resource Blocks, Mapping from Virtual to PRBs, baseband signal generation, and modulation and Upconversion.

In one embodiment, the channel coding is polar-code-based.

In one embodiment, the channel coding is LDPC-code-based.

The present disclosure provides a method in a first node for wireless communications, comprising:

transmitting a first radio signal on a first radio resource;

herein, the first radio signal comprises a first signaling, the first signaling comprising first information; whether the first signaling comprises second information is related to the first information, and the first information in the first signaling indicates whether the first node is in coverage.

The present disclosure provides a method in a first node for wireless communications, comprising:

transmitting a first radio signal on a first radio resource;

herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

The present disclosure provides a method in a first node for wireless communications, comprising:

transmitting a first radio signal on a first radio resource;

herein, the first radio signal comprises a first signaling, the first signaling comprising first information; the first information in the first signaling indicates whether the first signaling comprises second information.

In one embodiment, a problem needed to be solved in the present disclosure is: in 5G NR system, since transmission conditions of radio signals on different radio resources are different, when a UE receives multiple radio signals from different radio resources, synchronization priorities of the multiple radio signals are different; when a UE only receives one radio signal from one radio resource, how can the UE determine a transmission timing transmitting a radio signal on another radio resource. In the scenario of carrier aggregation or multi-antenna, the above method flexibly indicates whether a reception timing of a radio signal received on a radio resource can be used for determining a transmission timing for transmitting a radio signal on another radio resource according to synchronization priority conditions of the UE on different radio resources, thus improving utilization efficiency of signaling resources, which is easy to be forward compatible.

In one embodiment, the above method is characterized in that a connection is created between a first radio resource and a second radio resource.

In one embodiment, the above embodiment is characterized in that a connection is created between a first radio signal and a second radio signal.

In one embodiment, the above embodiment is characterized in that a connection is created between a first signaling and a second radio signal.

In one embodiment, the above embodiment is characterized in that a connection is created between first information and second information.

In one embodiment, the above method is advantageous in that second information in a first signaling indicates whether a reception timing of the first radio signal can be used for determining transmission timings of second radio signals transmitted on different radio resources.

In one embodiment, the above method is advantageous in whether a first signaling comprises second information is related to first information, thus improving utilization efficiency of signaling resources, which is easy to be forward compatible.

In one embodiment, the above method is characterized in that when the first node is in coverage, the first signaling comprises the second information.

In one embodiment, the above method is characterized in that when the first node is out of coverage, the first signaling does not comprise the second information.

According to one aspect of the present disclosure, the above method is characterized in comprising:

judging whether the first node is in coverage;

herein, the first information in the first signaling indicates whether the first node is in coverage; only when the first node is in coverage, the first signaling may comprise the second information.

According to one aspect of the present disclosure, the above method is characterized in comprising:

receiving a second signaling, the second signaling indicating Q2 radio resource(s), Q2 being a positive integer;

herein, the Q2 radio resource(s) comprises (comprise) the Q1 radio resource(s); and the first information in the first signaling indicates the Q1 radio resource(s).

According to one aspect of the present disclosure, the above method is characterized in comprising:

performing channel coding on all bits in the first signaling to obtain a second bit block;

herein, the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

According to one aspect of the present disclosure, the above method is characterized in comprising:

receiving a target-specific signal, and judging whether the first node is in coverage according to target received quality of the target-specific signal.

According to one aspect of the present disclosure, the above method is characterized in that the second information in the first signaling indicates whether a reception timing of the first radio signal can be used for determining transmission timings of radio signals transmitted on the Q1 radio resources, Q1 being a positive integer greater than 1.

According to one aspect of the present disclosure, the above method is characterized in comprising:

receiving a second radio signal on the second radio resource;

herein, when the second information in the first signaling indicates that a reception timing of the first radio signal can be used for determining transmission timing(s) on the Q1 radio resource(s), a reception timing of the first radio signal is used for determining a transmission timing of the second radio signal, otherwise a transmission timing of the second radio signal is unrelated to a reception timing of a radio signal transmitted by the first node.

According to one aspect of the present disclosure, the above method is characterized in that the first node is a UE.

According to one aspect of the present disclosure, the above method is characterized in that the first node is a relay node.

The present disclosure provides a method in a second node for wireless communications, comprising:

receiving a first radio signal on a first radio resource;

herein, the first radio signal comprises a first signaling, the first signaling comprising first information; whether the first signaling comprises second information is related to the first information, and the first information in the first signaling indicates whether the first node is in coverage.

The present disclosure provides a method in a second node for wireless communications, comprising:

receiving a first radio signal on a first radio resource;

herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

The present disclosure provides a method in a second node for wireless communications, comprising:

receiving a first radio signal on a first radio resource;

herein, the first radio signal comprises a first signaling, the first signaling comprising first information; the first information in the first signaling indicates whether the first signaling comprises second information.

According to one aspect of the present disclosure, the above method is characterized in that the first information in the first signaling indicates whether a transmitter of the first radio signal is in coverage, only when the first information in the first signaling indicates that the transmitter of the first radio signal is in coverage, the first signaling may comprise the second information.

According to one aspect of the present disclosure, the above method is characterized in that Q2 radio resource(s) is(are) indicated by a second signaling, Q2 being a positive integer; the Q2 radio resource(s) comprises (comprise) the Q1 radio resource(s); and the first information in the first signaling indicates the Q1 radio resource(s).

According to one aspect of the present disclosure, the above method is characterized in comprising:

performing channel decoding on a second bit block to obtain all bits in the first signaling;

herein, the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

According to one aspect of the present disclosure, the above method is characterized in comprising:

determining a transmission timing for transmitting a radio signal on a second radio resource according to the second information in the first signaling;

herein, the second radio resource is one of the Q1 radio resources other than the first radio resource, Q1 being greater than 1; the second information in the first signaling indicates whether a reception timing of the first radio signal can be used for determining transmission timings on the Q1 radio resources.

According to one aspect of the present disclosure, the above method is characterized in comprising:

transmitting a second radio signal on the second radio resource;

herein, when the second information in the first signaling indicates that a reception timing of the first radio signal can be used for determining (a) transmission timing(s) for transmitting (a) radio signal(s) on the Q1 radio resource(s), a reception timing of the first radio signal is used for determining a transmission timing of the second radio signal, otherwise a transmission timing of the second radio signal is unrelated to a reception timing of a radio signal transmitted by a transmitter of the first radio signal.

According to one aspect of the present disclosure, the above method is characterized in that the second node is a UE.

According to one aspect of the present disclosure, the above method is characterized in that the second node is a relay node.

The present disclosure provides a first node for wireless communications, comprising:

a first transmitter: transmitting a first radio signal on a first radio resource;

herein, the first radio signal comprises a first signaling, the first signaling comprising first information; whether the first signaling comprises second information is related to the first information, and the first information in the first signaling indicates whether the first node is in coverage.

The present disclosure provides a first node for wireless communications, comprising:

a first transmitter: transmitting a first radio signal on a first radio resource;

herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

The present disclosure provides a first node for wireless communications, comprising:

a first transmitter: transmitting a first radio signal on a first radio resource;

herein, the first radio signal comprises a first signaling, the first signaling comprising first information; the first information in the first signaling indicates whether the first signaling comprises second information.

According to one aspect of the present disclosure, the above first node is characterized in comprising:

a first receiver: judging whether the first node is in coverage;

herein, the first information in the first signaling indicates whether the first node is in coverage; only when the first node is in coverage, the first signaling may comprise the second information.

According to one aspect of the present disclosure, the above first node is characterized in comprising:

the first receiver receiving a second signaling, the second signaling indicating Q2 radio resource(s), Q2 being a positive integer;

herein, the Q2 radio resource(s) comprises (comprise) the Q1 radio resource(s); and the first information in the first signaling indicates the Q1 radio resource(s).

According to one aspect of the present disclosure, the above first node is characterized in comprising:

the first transmitter performing channel coding on all bits in the first signaling to obtain a second bit block;

herein, the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

According to one aspect of the present disclosure, the above first node is characterized in comprising:

a first receiver receiving a target-specific signal, and judging whether the first node is in coverage according to target received quality of the target-specific signal.

According to one aspect of the present disclosure, the above first node is characterized in that the second information in the first signaling indicates whether a reception timing of the first radio signal can be used for determining transmission timings of radio signals transmitted on the Q1 radio resources, Q1 being a positive integer greater than 1.

According to one aspect of the present disclosure, the above first node is characterized in comprising:

the first receiver receiving a second radio signal on a second radio resource;

herein, when the second information in the first signaling indicates that a reception timing of the first radio signal can be used for determining transmission timing(s) on the Q1 radio resource(s), a reception timing of the first radio signal is used for determining a transmission timing of the second radio signal, otherwise a transmission timing of the second radio signal is unrelated to a reception timing of a radio signal transmitted by the first node.

According to one aspect of the present disclosure, the above first node is characterized in that the first node is a UE.

According to one aspect of the present disclosure, the above first node is characterized in that the first node is a relay node.

The present disclosure provides a second node for wireless communications, comprising:

a second receiver: receiving a first radio signal on a first radio resource;

herein, the first radio signal comprises a first signaling, the first signaling comprising first information; whether the first signaling comprises second information is related to the first information, and the first information in the first signaling indicates whether the first node is in coverage.

The present disclosure provides a second node for wireless communications, comprising:

a second receiver: receiving a first radio signal on a first radio resource;

herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

The present disclosure provides a second node for wireless communications, comprising:

a second receiver: receiving a first radio signal on a first radio resource;

herein, the first radio signal comprises a first signaling, the first signaling comprising first information; the first information in the first signaling indicates whether the first signaling comprises second information.

According to one aspect of the present disclosure, the above second node is characterized in that the first information in the first signaling indicates whether a transmitter of the first radio signal is in coverage, only when the first information in the first signaling indicates that the transmitter of the first radio signal is in coverage, the first signaling may comprise the second information.

According to one aspect of the present disclosure, the above second node is characterized in that Q2 radio resource(s) is(are) indicated by a second signaling, Q2 being a positive integer; the Q2 radio resource(s) comprises (comprise) the Q1 radio resource(s); the Q1 radio resource(s) is(are) indicated by the first information in the first signaling.

According to one aspect of the present disclosure, the above second node is characterized in comprising:

the second receiver performing channel decoding on a second bit block to obtain all bits in the first signaling;

herein, the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

According to one aspect of the present disclosure, the above second node is characterized in comprising:

a second transmitter: determining a transmission timing for transmitting a radio signal on a second radio resource according to the second information in the first signaling;

herein, the second radio resource is one of the Q1 radio resources other than the first radio resource, Q1 being greater than 1; the second information in the first signaling indicates whether a reception timing of the first radio signal can be used for determining transmission timings on the Q1 radio resources.

According to one aspect of the present disclosure, the above second node is characterized in comprising:

the second transmitter transmitting a second radio signal on the second radio resource;

herein, when the second information in the first signaling indicates that a reception timing of the first radio signal can be used for determining (a) transmission timing(s) for transmitting (a) radio signal(s) on the Q1 radio resource(s), a reception timing of the first radio signal is used for determining a transmission timing of the second radio signal, otherwise a transmission timing of the second radio signal is unrelated to a reception timing of a radio signal transmitted by a transmitter of the first radio signal.

According to one aspect of the present disclosure, the above second node is characterized in that the second node is a UE.

According to one aspect of the present disclosure, the above second node is characterized in that the second node is a relay node.

In one embodiment, the present disclosure is advantageous in the following aspects:

The present disclosure creates a connection between a first radio resource and a second radio resource.

The present disclosure creates a connection between a first radio signal and a second radio signal.

The present disclosure creates a connection between a first signaling and a second radio signal.

The present disclosure creates a connection between first information and second information.

Second information in a first signaling in the present disclosure indicates whether a reception timing of the first radio signal can be used for determining transmission timings of second radio signals transmitted on different radio resources.

Whether a first signaling in the present disclosure comprises second information is related to first information, thus improving utilization efficiency of signaling resources, which is easy to be forward compatible.

For the first node being in coverage in the present disclosure, the first signaling comprises the second information.

For the first node being out of coverage in the present disclosure, the first signaling does not comprise the second information.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of a first radio signal transmission according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication device and a second communication device according to one embodiment of the present disclosure.

FIG. 5 illustrates a flowchart of a radio signal transmission according to one embodiment of the present disclosure.

FIG. 6 illustrates a flowchart of determining whether a first signaling comprises second information according to one embodiment of the present disclosure.

FIG. 7 illustrates a schematic diagram of first information indicating Q1 radio resource(s) according to one embodiment of the present disclosure.

FIG. 8 illustrates a schematic diagram of a time-frequency resource unit according to one embodiment of the present disclosure.

FIG. 9 illustrates a schematic diagram of a relationship of Q1 radio resource(s) according to one embodiment of the present disclosure.

FIG. 10 illustrates a schematic diagram of a relationship between antenna ports and antenna groups according to one embodiment of the present disclosure.

FIG. 11 illustrates a schematic diagram of relationship of Q1 radio resource(s) according to another embodiment of the present disclosure.

FIG. 12 illustrates a schematic diagram of a relationship between positions of a first node and a second node according to one embodiment of the present disclosure.

FIG. 13 illustrates a schematic diagram of a relationship between a fifth radio resource and a sixth radio resource according to one embodiment of the present disclosure.

FIG. 14 illustrates a schematic diagram of a relationship among first information, third information, a second bit block and a first radio signal according to one embodiment of the present disclosure.

FIG. 15 illustrates a structure block diagram of a processing device in a first node according to one embodiment of the present disclosure.

FIG. 16 illustrates a structure block diagram of a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

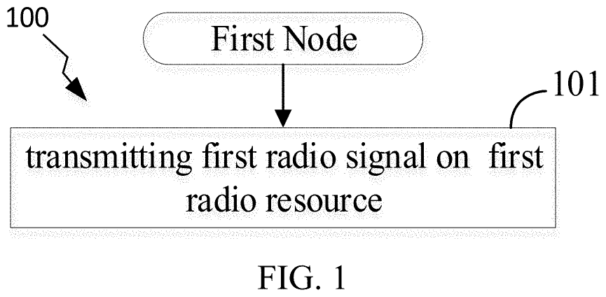

Embodiment 1 illustrates a flowchart of a first radio signal transmission, as shown in FIG. 1.

In Embodiment 1, a first radio signal in the present disclosure is transmitted on a first radio resource; the first radio signal comprises a first signaling, the first signaling comprising first information; and whether the first signaling comprises second information is related to the first information.

In one embodiment, the first radio resource is determined out of the Q1 radio resource(s).

In one embodiment, Q1 radio resource(s) is(are) candidate resource(s) for transmitting the first radio signal.

In one embodiment, the Q1 radio resource(s) comprises (comprise) the first radio resource.

In one embodiment, the first radio resource is one of Q1 radio resource(s).

In one embodiment, a first node in the present disclosure determines the first radio resource by itself.

In one embodiment, a first node in the present disclosure selects the first radio resource out of the Q1 radio resource(s) by itself.

In one embodiment, a first node in the present disclosure is configured to select the first radio resource out of the Q1 radio resource(s).

In one embodiment, the first radio resource being selected out of the Q1 radio resource(s) is related to target received quality of a received target-specific signal.

In one embodiment, a first node in the present disclosure selects the first radio resource out of the Q1 radio resource(s) according to target received quality of a target-specific signal.

In one embodiment, the first radio signal comprises the first-type signal in the present disclosure.

In one embodiment, the first radio signal comprises the second-type signal in the present disclosure.

In one embodiment, the first radio signal comprises the third-type signal in the present disclosure.

In one embodiment, the first radio signal is transmitted in the first-type channel in the present disclosure.

In one embodiment, the first radio signal is transmitted in the second-type channel in the present disclosure.

In one embodiment, the first radio signal is transmitted in the third-type channel in the present disclosure.

In one embodiment, the first radio signal comprises a first CB, the first CB comprising a positive integer number of sequentially-arranged bits.

In one embodiment, the first CB comprises one or more Fields in a Master Information Block (MIB).

In one embodiment, the first CB comprises one or more fields in a Master Information Block-Sidelink (MIB-SL).

In one embodiment, the first CB comprises one or more fields in a Master Information Block-V2X-Sidelink (MIB-V2X-SL).

In one embodiment, the first CB comprises one or more Fields in a System Information Block (SIB).

In one embodiment, the first radio signal is obtained by all or part of bits of the first CB through the first preprocessing in the present disclosure.

In one embodiment, the first radio signal is obtained by all or part of bits of the first CB through the second preprocessing in the present disclosure.

In one embodiment, the first radio signal is an output of all or part of bits of the first CB through the first preprocessing in the present disclosure.

In one embodiment, the first radio signal is an output of all or part of bits of the first CB through the second preprocessing in the present disclosure.

In one embodiment, the first Code Block is one CB.

In one embodiment, the first Code Block is one TB.

In one embodiment, the first CB is obtained by one TB through a TB-level CRC attachment.

In one embodiment, the first CB is one of CB(s) obtained by a TB sequentially through TB-level CRC attachment, CB Segmentation, and CB-level CRC attachment.

In one embodiment, only the first CB is used for generating the first radio signal.

In one embodiment, there exists a CB other than the first CB also being used for generating the first radio signal.

In one embodiment, the first CB comprises the first information.

In one embodiment, the first CB comprises the first information and the second information.

In one embodiment, the first CB does not comprise the second information.

In one embodiment, the first signaling is semi-statically configured.

In one embodiment, the first signaling is dynamically-configured.

In one embodiment, the first signaling is Broadcast.

In one embodiment, the first signaling is Groupcast.

In one embodiment, the first signaling is Unicast.

In one embodiment, the first signaling comprises all or part of a higher-layer signaling.

In one embodiment, the first signaling comprises all or part of a Radio Resource Control Layer signaling.

In one embodiment, the first signaling comprises one or more Fields in an RRC Information Element (IE).

In one embodiment, the first signaling comprises all or part of a Multimedia Access Control Layer (MAC layer) signaling.

In one embodiment, the first signaling comprises one or more fields in a MAC Control Element (CE).

In one embodiment, the first signaling comprises one or more fields in a PHY layer.

In one embodiment, the first signaling comprises one or more fields in a Downlink Control Information (DCI).

In one embodiment, the first signaling comprises one or more fields in a Sidelink Control Information (SCI).

In one embodiment, the specific meaning of the SCI can be found in 3GPP TS36. 212, section 5. 4. 3.

In one embodiment, the first signaling comprises one or more fields in an MIB.

In one embodiment, the first signaling comprises one or more fields in an MIB-SL.

In one embodiment, the specific meaning of the MIB-SL can be found in 3GPP TS36. 331, section 6. 5. 2.

In one embodiment, the first signaling comprises one or more fields in an MIB-V2X-SL.

In one embodiment, the specific meaning of the MIB-V2X-SL can be found in 3GPP TS36. 331, section 6. 5. 2.

In one embodiment, the first signaling comprises one or more fields in an SIB.

In one embodiment, the first signaling comprises one or more fields in an SCI format 0.

In one embodiment, the first signaling comprises one or more fields in an SCI format 1.

In one embodiment, the specific meaning of the SCI format 0 can found in 3GPP TS36. 212, section 5. 4. 3. 1.

In one embodiment, the specific meaning of the SCI format 0 can found in 3GPP TS36. 212, section 5. 4. 3. 1.

In one embodiment, the first signaling comprises a first sub-CB, the first sub-CB comprising a positive integer number of sequentially-arranged bits.

In one embodiment, the first signaling is obtained by all or part of bits of the first sub-CB subjected to the first preprocessing in the present disclosure.

In one embodiment, the first signaling is obtained by all or part of bits of the first sub-CB subjected to the second preprocessing in the present disclosure.

In one embodiment, the first signaling is an output of all or part of bits of the first sub-CB subjected to at least one of the first preprocessing in the present disclosure.

In one embodiment, the first signaling is an output of all or part of bits of the first sub-CB subjected to at least one of the second preprocessing in the present disclosure.

In one embodiment, the first sub-CB is a CB.

In one embodiment, the first sub-CB is a TB.

In one embodiment, the first sub-CB is obtained by a TB subjected to a TB-level CRC attachment.

In one embodiment, the first sub-CB is one of CB(s) obtained by a TB sequentially subjected to TB-level CRC attachment, CB Segmentation, and CB-level CRC attachment.

In one embodiment, only the first sub-CB is used for generating the first signaling.

In one embodiment, there exists a CB other than the first sub-CB also being used for generating the first signaling.

In one embodiment, the first sub-CB comprises the first information.

In one embodiment, the first sub-CB comprises the second information.

In one embodiment, the first sub-CB comprises the first information and the second information.

In one embodiment, the first sub-CB does not comprise the second information.

In one embodiment, the first radio signal comprises a first signaling, the first signaling comprising the first information.

In one embodiment, the first radio signal comprises a first signaling, the first signaling comprising the first information and the second information.

In one embodiment, the first radio signal comprises a first signaling, the first signaling does not comprise second information.

In one embodiment, the first radio signal comprises a first signaling, the first signaling comprises the first information, and whether the first signaling comprises second information is related to the first information.

In one embodiment, the first signaling comprises a positive integer number of first-type Field(s), each of the positive integer number of first-type field(s) consists of a positive integer number of bit(s), and the first information is one of the positive integer number of first-type field(s); when the first signaling comprises the second information, the second information in the first signaling is one of the positive integer number of first-type field(s).

In one embodiment, the first signaling comprises a positive integer number of first-type Field(s), each of the positive integer number of first-type field(s) consists of a positive integer number of bit(s), and the second information in the first signaling is one of the positive integer number of first-type field(s).

In one embodiment, the first signaling comprises a positive integer number of first-type Field(s), each of the positive integer number of first-type field(s) consists of a positive integer number of bits, and the second information in the first signaling is part of bits in one of the positive integer number of first-type field(s).

In one embodiment, the first signaling comprises a positive integer number of first-type Field(s), each of the positive integer number of first-type field(s) consists of a positive integer number of bit(s), and when the first signaling comprises the second information, the second information in the first signaling is one of the positive integer number of first-type field(s).

In one embodiment, the first signaling comprises a positive integer number of first-type Field(s), each of the positive integer number of first-type field(s) consists of a positive integer number of bits, and when the first signaling comprises the second information, the second information in the first signaling is part of bits in one of the positive integer number of first-type field(s).

In one embodiment, the first signaling comprises a positive integer number of first-type field(s), each of the positive integer number of first-type field(s) consists of a positive integer number of bits, reserved bits are one of the positive integer number of first-type field(s), when the first signaling comprises the second information, the second information in the first signaling is all or part of bits of the reserved bits.

In one embodiment, the first signaling comprises a positive integer number of first-type Field(s), each first-type field in the positive integer number of first-type field(s) consists of a positive integer number of bit(s), the first signaling implicitly comprises the first information; when the first signaling comprises the second information, the second information in the first signaling is one of the positive integer number of first-type field(s).

In one subembodiment of the above embodiment, the first signaling implicitly comprising the first information means that the first information is used for scrambling the first CB.

In one subembodiment of the above embodiment, the first signaling implicitly comprising the first information means that the first information is used for generating a scrambling sequence for scrambling the first CB.

In one subembodiment of the above embodiment, the first signaling implicitly comprising the first information means that an initial value of a scrambling sequence for scrambling the first CB is related to the first information.

In one subembodiment of the above embodiment, the first signaling implicitly comprising the first information means that the first information is used for generating a TB-level CRC performed on the first CB.

In one subembodiment of the above embodiment, the first signaling implicitly comprising the first information means that the first information is used for generating a CB-level CRC performed on the first CB.

In one subembodiment of the above embodiment, the first signaling implicitly comprising the first information means that the first information is used for scrambling the first sub-CB.

In one subembodiment of the above embodiment, the first signaling implicitly comprising the first information means that the first information is used for generating a scrambling sequence for scrambling the first sub-CB.

In one subembodiment of the above embodiment, the first signaling implicitly comprising the first information means that an initial value of a scrambling sequence for scrambling the first sub-CB is related to the first information.

In one subembodiment of the above embodiment, the first signaling implicitly comprising the first information means that the first information is used for generating a TB-level CRC performed on the first sub-CB.

In one subembodiment of the above embodiment, the first signaling implicitly comprising the first information means that the first information is used for generating a CB-level CRC performed on the first sub-CB.

In one subembodiment of the above embodiment, the first signaling implicitly comprising the first information means that the first information is used for generating a DMRS for demodulating the first radio signal.

In one subembodiment of the above embodiment, the first signaling implicitly comprising the first information means that the first information is used for generating a DMRS for demodulating the first signaling.

In one embodiment, a payload size of the first signaling is unrelated to whether the first signaling comprises the second information.

In one embodiment, a number of bits comprised in the first signaling is unrelated to whether the first signaling comprises the second information.

In one embodiment, the first signaling is transmitted on the third-type channel in the present disclosure.

In one embodiment, the first signaling is transmitted on the second-type channel in the present disclosure.

In one embodiment, the first signaling is transmitted on the first-type channel in the present disclosure.

In one embodiment, the first information comprises all or part of a higher-layer signaling.

In one embodiment, the first information comprises all or part of an RRC signaling.

In one embodiment, the first information comprises one or more fields of an RRC IE.

In one embodiment, the first information comprises all or part of a MAC layer signaling.

In one embodiment, the first information comprises one or more fields of a MAC CE.

In one embodiment, the first information comprises one or more fields of a PHY layer.

In one embodiment, the first information comprises one or more fields of DCI.

In one embodiment, the first information comprises one or more fields of SCI.

In one embodiment, the first information comprises one or more fields in an MIB.

In one embodiment, the first information comprises one or more fields in an MIB-SL.

In one embodiment, the first information comprises one or more fields in an MIB-V2X-SL.

In one embodiment, the first information comprises one or more fields in an SIB.

In one embodiment, the first information comprises one or more fields in an SCI format 0.

In one embodiment, the first information comprises one or more fields in an SCI format 1.

In one embodiment, the first information comprises a first bit string, the first bit string comprising a positive integer number of sequentially-arranged bits.

In one embodiment, the first CB comprises the first bit string.

In one embodiment, the first information in the first signaling is generated at the PHY.

In one embodiment, the first information is used for performing scrambling on the first CB.

In one embodiment, the first information is used for generating a scrambling sequence for scrambling the first CB.

In one embodiment, an initial value of a scrambling sequence for scrambling the first CB is related to the first information.

In one embodiment, the first information is used for generating a TB-level CRC performed on the first CB.

In one embodiment, the first information is used for generating a CB-level CRC performed on the first CB.

In one embodiment, the first sub-CB comprises the first bit string.

In one embodiment, the first information is used for performing scrambling on the first sub-CB.

In one embodiment, the first information is used for generating a scrambling sequence for scrambling the first sub-CB.

In one embodiment, an initial value of a scrambling sequence for scrambling the first sub-CB is related to the first information.

In one embodiment, the first information is used for generating a TB-level CRC performed on the first sub-CB.

In one embodiment, the first information is used for generating a CB-level CRC performed on the first sub-CB.

In one embodiment, the first information is used for generating a DMRS of the first radio signal.

In one embodiment, the first information indicates Q1 radio resource(s) in the present disclosure, Q1 being a positive integer.

In one embodiment, when the first information indicates the Q1 radio resource(s), Q1 being a positive integer, and the first signaling comprises the second information.

In one embodiment, when the first information does not indicate the Q1 radio resource(s), Q1 being a positive integer, and the first signaling does not comprise the second information.

In one embodiment, when the first information indicates the Q1 radio resources, Q1 being a positive integer greater than 1, and the first signaling comprises the second information.

In one embodiment, when the first information indicates the Q1 radio resource, Q1 being equal to 1, and the first signaling does not comprise the second information.

In one embodiment, when the first information only indicates the first radio resource, the first signaling does not comprise the second information.

In one embodiment, when the Q1 is greater than 1 and the first node is in coverage, the first signaling comprises the second information, otherwise the first signaling does not comprise the second information.

In one embodiment, when the Q1 is greater than 1, the first signaling comprises the second information, otherwise the first signaling does not comprise the second information.

In one embodiment, the first information explicitly indicates whether the first signaling comprises second information.

In one embodiment, if the first information is a Boolean value “TRUE”, the first signaling comprises the second information.

In one embodiment, if the first information is a Boolean value “FALSE”, the first signaling does not comprise the second information.

In one embodiment, a bit in the first CB corresponding to the first information is 1, the first signaling comprises the second information.

In one embodiment, a bit in the first CB corresponding to the first information is 0, the first signaling does not comprise the second information.

In one embodiment, a bit in the first sub-CB corresponding to the first information is 1, the first signaling comprises the second information.

In one embodiment, a bit in the first sub-CB corresponding to the first information is 0, the first signaling does not comprise the second information.

In one embodiment, the first information implicitly indicates whether the first signaling comprises second information.

In one embodiment, a first scrambling sequence group comprises a positive integer number of first-type scrambling sequence(s), at least one of the positive integer number of first-type scrambling sequence(s) is used for scrambling the first CB.

In one embodiment, the first information is used for determining a scrambling sequence of the first CB.

In one embodiment, the first information is used for selecting one first-type scrambling sequence out of the first scrambling sequence group.

In one embodiment, the first information is used for selecting one first-type scrambling sequence out of the first scrambling sequence group to perform scrambling on the first CB.

In one embodiment, a first scrambling sequence is one of the positive integer number of first-type scrambling sequence(s), a second scrambling sequence is another of the positive integer number of first-type scrambling sequence(s), the first scrambling sequence being different from the second scrambling sequence.

In one embodiment, when the first CB is scrambled by the first scrambling sequence, the first signaling comprises the second information.

In one embodiment, when the first CB is scrambled by the second scrambling sequence, the first signaling does not comprise the second information.

In one embodiment, the second information comprises all or part of a higher-layer signaling.

In one embodiment, the second information comprises all or part of an RRC signaling.

In one embodiment, the second information comprises one or more fields of an RRC IE.

In one embodiment, the second information comprises all or part of a MAC layer signaling.

In one embodiment, the second information comprises one or more fields of a MAC CE.

In one embodiment, the second information comprises one or more fields of a PHY layer.

In one embodiment, the second information comprises one or more fields of DCI.

In one embodiment, the second information comprises one or more fields of SCI.

In one embodiment, the second information comprises one or more fields of an MIB.

In one embodiment, the second information comprises one or more fields of an MIB-SL.

In one embodiment, the second information comprises one or more fields of an MIB-V2X-SL.

In one embodiment, the second information comprises one or more fields of an SIB.

In one embodiment, the second information comprises one or more fields of SCI format 0.

In one embodiment, the second information comprises one or more fields in SCI format 1.

In one embodiment, the second information comprises a second bit string, the second bit string comprising a positive integer number of sequentially-arranged bit(s).

In one embodiment, the first CB comprises the second bit string.

In one embodiment, the second information is used for performing scrambling on the first CB.

In one embodiment, the second information is used for generating a scrambling sequence for scrambling the first CB.

In one embodiment, an initial value of a scrambling sequence for scrambling the first CB is related to the second information.

In one embodiment, the second information is used for generating a TB-level CRC performed on the first CB.

In one embodiment, the second information is used for generating a CB-level CRC performed on the first CB.

In one embodiment, the first sub-CB comprises the second bit string.

In one embodiment, the second information is used for performing scrambling on the first sub-CB.

In one embodiment, the second information is used for generating a scrambling sequence for scrambling the first sub-CB.

In one embodiment, an initial value of a scrambling sequence for scrambling the first sub-CB is related to the second information.

In one embodiment, the second information is used for generating a TB-level CRC performed on the first sub-CB.

In one embodiment, the second information is used for generating a CB-level CRC performed on the first sub-CB.

In one embodiment, the second information is used for generating a Demodulation Reference Signal of the first radio signal.

In one embodiment, the Q1 is a positive integer greater than 1, and the Q1 radio resources comprise the first radio resource and a third radio resource.

In one embodiment, the Q1 is a positive integer greater than 1, a third radio resource is one of the Q1 radio resources, and the third radio resource is different from the first radio resource.

In one embodiment, the Q1 is a positive integer greater than 1, a third radio resource is one of the Q1 radio resources, and the third radio resource is different from the first radio resource in frequency domain.

In one embodiment, the Q1 is a positive integer greater than 1, a third radio resource is one of the Q1 radio resources, and the third radio resource is different from the first radio resource in time domain.

In one embodiment, the Q1 is a positive integer greater than 1, a third radio resource is one of the Q1 radio resources, and the third radio resource is different from the first radio resource in space domain.

In one embodiment, the second information indicates whether the first radio signal can be used for the Q1 radio resource(s).

In one embodiment, the second information indicates whether the first radio signal can be used for (a) radio signal(s) transmitted on the Q1 radio resource(s).

In one embodiment, the second information indicates whether the first radio signal is used for a Carrier Aggregation (CA).

In one embodiment, the second information indicates whether the first radio signal is used for a positive integer number of carrier(s).

In one embodiment, the second information indicates whether the first radio signal is used for a positive integer number of BWP(s).

In one embodiment, the second information indicates whether the first radio signal is used for a positive integer number of spatial parameter(s).

In one embodiment, the second information indicates whether the first radio signal can be used for the third radio resource.

In one embodiment, the second information indicates whether the first radio signal can be used for (a) radio signal(s) transmitted on the third radio resource.

In one embodiment, the second information indicates a Subcarrier Spacing (SCS) of a radio signal transmitted on the third radio resource.

In one embodiment, the second information indicates a maximum number of PRBs on the third radio resource that can be used for transmitting a radio signal.

In one embodiment, the second information indicates a number of PRBs on the third radio resource used for transmitting a radio signal.

In one embodiment, the second information indicates a slot on the third radio resource that can be used for transmitting a radio signal.

In one embodiment, the second information indicates a slot on the third radio resource used for transmitting a radio signal.

In one embodiment, the second information indicates a spatial parameter on the third radio resource that can be used for transmitting a radio signal.

In one embodiment, the second information indicates a spatial parameter on the third radio resource used for transmitting a radio signal.

### Embodiment 2

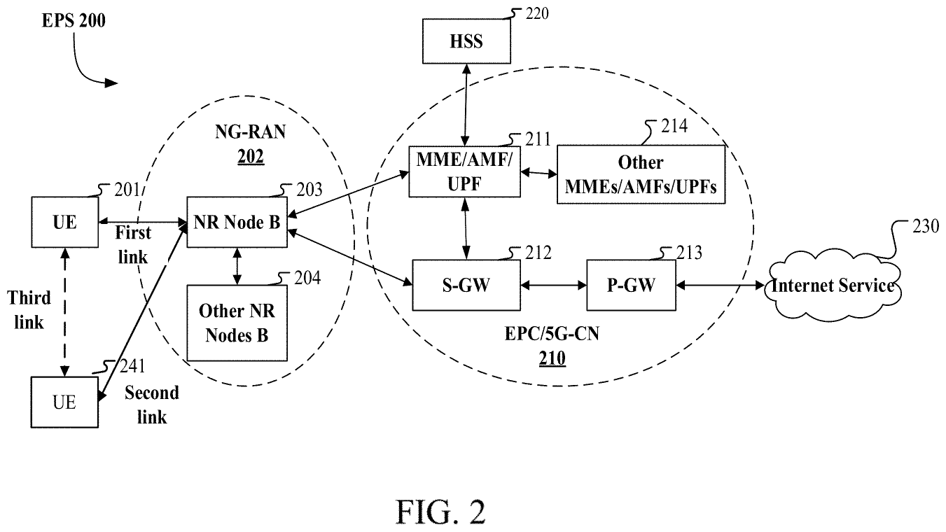

Embodiment 2 illustrates a schematic diagram of a network architecture according to the present disclosure, as shown in FIG. 2.

FIG. 2 is a diagram illustrating a network architecture 200 of 5G NR, Long-Term Evolution (LTE), and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present disclosure can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmit-Receive Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present disclosure comprises the UE 201.

In one embodiment, the UE in the present disclosure comprises the UE 201.

In one embodiment, the second node in the present disclosure comprises the UE 241.

In one embodiment, the UE in the present disclosure comprises the UE 241.

In one embodiment, the base station in the present disclosure comprises the gNB 203.

In one embodiment, the UE 201 supports Sidelink communications.

In one embodiment, the UE 241 supports Sidelink communications.

In one embodiment, the UE 201 supports CA-based Sidelink communications.

In one embodiment, the UE 241 supports CA-based Sidelink communications.

In one embodiment, the UE 201 supports BWP-based Sidelink communications.

In one embodiment, the UE 241 supports BWP-based Sidelink communications.

In one embodiment, the UE 201 supports beamforming-based Sidelink communications.

In one embodiment, the UE 241 supports beamforming-based Sidelink communications.

In one embodiment, the gNB 203 supports CA-based Downlink transmission.

In one embodiment, the gNB 203 supports beamforming-based DL transmission.

In one embodiment, the UE 201 supports multicarrier-based Sidelink communications.

In one embodiment, the UE 241 supports multicarrier-based Sidelink communications.

In one embodiment, the UE 201 supports multiple-BWP-based Sidelink communications.

In one embodiment, the UE 241 supports multiple-BWP-based Sidelink communications.

In one embodiment, the UE 201 supports Massive-MIMO-based Sidelink communications.

In one embodiment, the UE 241 supports Massive-MIMO-based Sidelink communications.

In one embodiment, the gNB 203 supports multicarrier-based downlink transmission.

In one embodiment, the gNB 203 supports multiple-BWP-based DL transmission.

In one embodiment, the gNB 203 supports Massive-MIMO-based DL transmission.

In one embodiment, a transmitter of a target-specific signal in the present disclosure comprises the Global Navigation Satellite System (GNSS).

In one embodiment, the GNSS comprises one or more of Global Positioning System (GPS), Galileo, Compass, GLONASS, Indian Regional Navigation Satellite System (IRNSS), and Quasi-Zenith Satellite System (QZSS).

In one embodiment, a transmitter of a target-specific signal in the present disclosure comprises a Cell.

In one embodiment, the Cell comprises a Serving Cell.

In one embodiment, the Cell comprises a Neighboring Cell.

In one embodiment, the Cell comprises a Primary cell.

In one embodiment, the Cell comprises a Secondary Cell.

In one embodiment, a transmitter of a target-specific signal in the present disclosure comprises the gNB 203.

In one embodiment, a transmitter of a second signaling in the present disclosure comprises the gNB 203.

In one embodiment, the GNSS in the present disclosure comprises the gNB 203.

In one embodiment, the Cell in the present disclosure comprises the gNB 203.

In one embodiment, the Serving Cell in the present disclosure comprises the gNB 203.

In one embodiment, the Primary Cell in the present disclosure comprises the gNB 203.

In one embodiment, the Secondary Cell in the present disclosure comprises the gNB 203.

In one embodiment, the UE 201 supports the action of judging whether the UE 201 is in coverage in the present disclosure based on the target-specific signal.

In one embodiment, a receiver of a second signaling in the present disclosure comprises the UE 201.

In one embodiment, a transmitter of a first radio signal in the present disclosure comprises the UE 201.

In one embodiment, a transmitter of a first signaling in the present disclosure comprises the UE 201.

In one embodiment, a receiver of a second radio signal in the present disclosure comprises the UE 201.

In one embodiment, a receiver of a first radio signal in the present disclosure comprises the UE 241.

In one embodiment, a transmitter of a second radio signal in the present disclosure comprises the UE 241.

### Embodiment 3

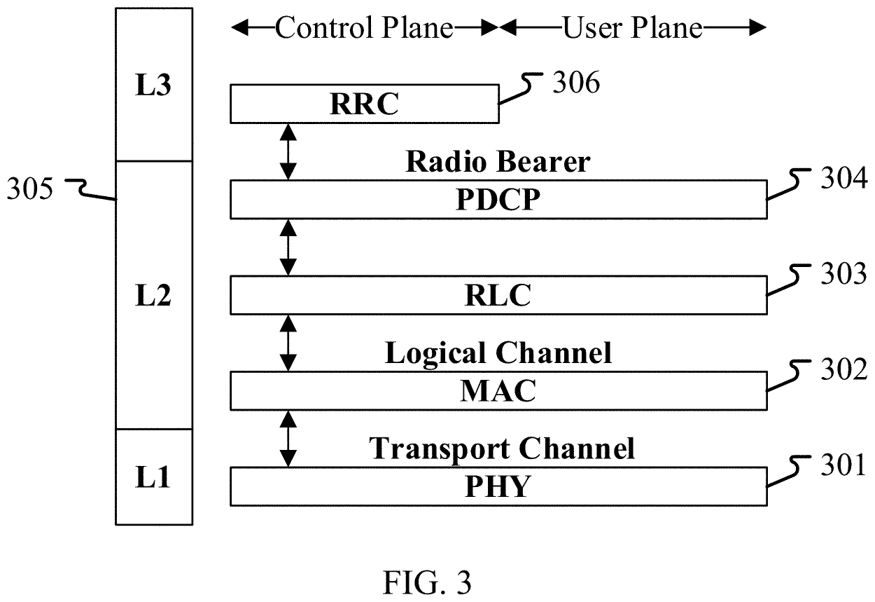

Embodiment 3 illustrates a schematic diagram of an example of a radio protocol architecture of a user plane and a control plane according to one embodiment of the present disclosure, as shown in FIG. 3.

FIG. 3 is a schematic diagram illustrating a radio protocol architecture of a user plane and a control plane. In FIG. 3, the radio protocol architecture for a UE and a base station (gNB or eNB) is represented by three layers, which are a layer 1, a layer 2 and a layer 3, respectively. The layer 1 (L1) is the lowest layer and performs signal processing functions of various PHY layers. A layer above the layer 1 belongs to a higher layer. The L1 is called PHY 301 in the present disclosure. The layer 2 (L2) 305 is above the PHY 301, and is in charge of the link between the UE and the base station via the PHY 301. In the user plane, L2 305 comprises a Medium Access Control (MAC) sublayer 302, a Radio Link Control (RLC) sublayer 303 and a Packet Data Convergence Protocol (PDCP) sublayer 304. All the three sublayers terminate at the base stations of the network side. Although not described in FIG. 3, the UE may comprise several higher layers above the L2 305, such as a network layer (i.e., IP layer) terminated at a P-GW 213 of the network side and an application layer terminated at the other side of the connection (i.e., a peer UE, a server, etc.). The PDCP sublayer 304 provides multiplexing among variable radio bearers and logical channels. The PDCP sublayer 304 also provides a header compression for a higher-layer packet so as to reduce a radio transmission overhead, provides security by encrypting a packet, and provides support for UE handover between base stations. The RLC sublayer 303 provides segmentation and reassembling of a higher-layer packet, retransmission of a lost packet, and reordering of a packet so as to compensate the disordered receiving caused by Hybrid Automatic Repeat reQuest (HARM). The MAC sublayer 302 provides multiplexing between a logical channel and a transport channel. The MAC sublayer 302 is also responsible for allocating between UEs various radio resources (i.e., resources block) in a cell. The MAC sublayer 302 is also in charge of HARQ operation. In the control plane, the radio protocol architecture of the UE and the base station is almost the same as the radio protocol architecture in the user plane on the PHY 301 and the L2 305, but there is no header compression for the control plane. The control plane also comprises a Radio Resource Control (RRC) sublayer 306 in the layer 3 (L3). The RRC sublayer 306 is responsible for obtaining radio resources (i.e., radio bearer) and configuring the lower layer using an RRC signaling between the base station and the UE.

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the radio protocol architecture in FIG. 3 is applicable to the base station in the present disclosure.

In one embodiment, the target-specific signal in the present disclosure is generated by the PHY 301.

In one embodiment, the second signaling in the present disclosure is generated by the PHY 301.

In one embodiment, the second signaling in the present disclosure is generated by the RRC sublayer 306.

In one embodiment, the first radio signal in the present disclosure is generated by the PHY 301.

In one embodiment, the first signaling in the present disclosure is generated by the RRC sublayer 306.

In one embodiment, the first signaling in the present disclosure is generated by the MAC sublayer 302.

In one embodiment, the first signaling in the present disclosure is generated by the PHY 301.

In one embodiment, the first information in the present disclosure is generated by the RRC sublayer 306.

In one embodiment, the first information in the present disclosure is generated by the MAC sublayer 302.

In one embodiment, the first information in the present disclosure is generated by the PHY 301.

In one embodiment, the second information in the present disclosure is generated by the RRC sublayer 306.

In one embodiment, the second information in the present disclosure is generated by the MAC sublayer 302.

In one embodiment, the second information in the present disclosure is generated by the PHY 301.

In one embodiment, the third information in the present disclosure is generated by the RRC sublayer 306.

In one embodiment, the third information in the present disclosure is generated by the MAC sublayer 302.

In one embodiment, the third information in the present disclosure is transferred from the L2 layer to the PHY 301.

In one embodiment, the third information in the present disclosure is transferred from the MAC sublayer 302 to the PHY 301.

In one embodiment, the first CB in the present disclosure is generated by the RRC sublayer 306.

In one embodiment, the first CB in the present disclosure is generated by the MAC sublayer 302.

In one embodiment, the first CB in the present disclosure is transferred from the L2 layer to the PHY 301.

In one embodiment, the first sub-CB in the present disclosure is generated by the RRC sublayer 306.

In one embodiment, the first sub-CB in the present disclosure is generated by the MAC sublayer 302.

In one embodiment, the first sub-CB in the present disclosure is transferred from the L2 layer to the PHY 301.

In one embodiment, the second CB in the present disclosure is generated by the RRC sublayer 306.

In one embodiment, the second CB in the present disclosure is generated by the MAC sublayer 302.

In one embodiment, the second CB in the present disclosure is transferred from the L2 layer to the PHY 301.

In one embodiment, a second bit block in the present disclosure is generated by the PHY 301.

In one embodiment, the second radio signal in the present disclosure is generated by the PHY 301.

### Embodiment 4

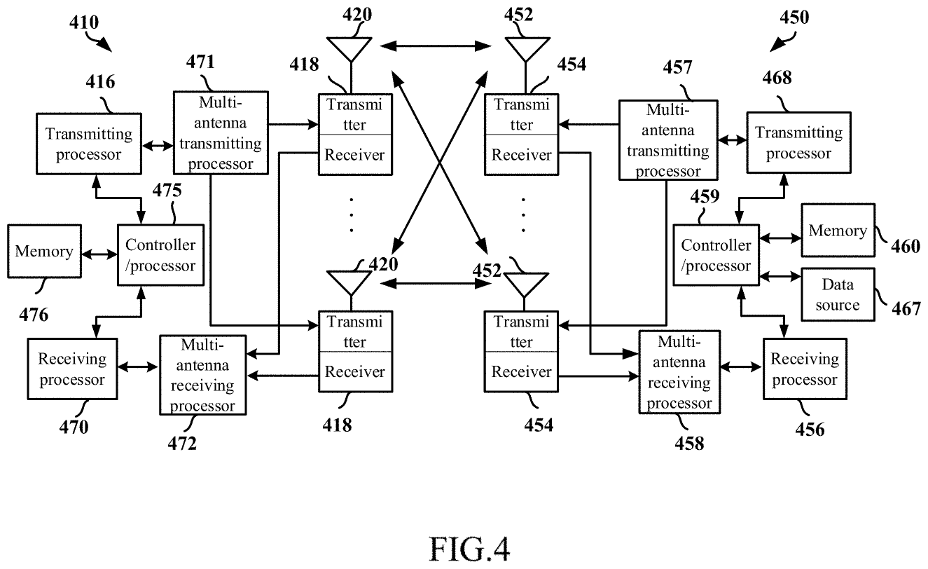

Embodiment 4 illustrates a schematic diagram of a first communication device and a second communication device in the present disclosure, as shown in FIG. 4. FIG. 4 is a block diagram of a first communication device 410 and a second communication device 450 that are in communication with each other in access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In one embodiment, the base station in the present disclosure comprises the first communication device 410, and the first node in the present disclosure comprises the second communication device 450.

In one subembodiment of the above embodiment, the first node is a UE.

In one subembodiment of the above embodiment, the first node is a relay node.

In one subembodiment of the above embodiment, the first communication device 410 comprises: at least one controller/processor; the at least one controller/processor is responsible for HARQ operation.

In one subembodiment of the above embodiment, the second communication device 450 comprises: at least one controller/processor; the at least one controller/processor is responsible for error detection using ACK and/or NACK protocols as a way to support HARQ operation.

In a transmission from the second communication device to the first communication device, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present disclosure comprises the second communication device 450, and the second node in the present disclosure comprises the first communication device 410.

In one subembodiment of the above embodiment, the first node and the second node are respectively UEs.

In one subembodiment of the above embodiment, the first node is a relay node, and the second node is a UE.

In one embodiment, the second communication device 450 comprises at least one processor and at least one memory. The at least one memory comprises computer program codes; the at least one memory and the computer program codes are configured to be used in collaboration with the at least one processor. The second communication device 450 at least transmits a first radio signal in the present disclosure on a first radio resource; herein, the first radio signal comprises a first signaling, the first signaling comprising first information; whether the first signaling comprises second information is related to the first information, and the first information in the first signaling indicates whether the first node is in coverage.

In one embodiment, the second communication device 450 comprises a memory that stores a computer readable instruction program. The computer readable instruction program generates an action when executed by at least one processor. The action includes transmitting a first radio signal in the present disclosure on a first radio resource; herein, the first radio signal comprises a first signaling, the first signaling comprising first information; whether the first signaling comprises second information is related to the first information, and the first information in the first signaling indicates whether the first node is in coverage.

In one embodiment, the second communication device 450 comprises at least one processor and at least one memory. The at least one memory comprises computer program codes; the at least one memory and the computer program codes are configured to be used in collaboration with the at least one processor. The second communication device 450 at least transmits a first radio signal in the present disclosure on a first radio resource; herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

In one embodiment, the second communication device 450 comprises a memory that stores a computer readable instruction program. The computer readable instruction program generates an action when executed by at least one processor. The action includes transmitting a first radio signal in the present disclosure on a first radio resource; herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

In one embodiment, the second communication device 450 at least one processor and at least one memory. The at least one memory comprises computer program codes; the at least one memory and the computer program codes are configured to be used in collaboration with the at least one processor. The second communication device 450 at least transmits a first radio signal in the present disclosure on a first radio resource; herein, the first radio signal comprises a first signaling, the first signaling comprising first information; the first information in the first signaling indicates whether the first signaling comprises second information.

In one embodiment, the second communication device 450 comprises a memory that stores a computer readable instruction program. The computer readable instruction program generates an action when executed by at least one processor. The action includes transmitting a first radio signal in the present disclosure on a first radio resource; herein, the first radio signal comprises a first signaling, the first signaling comprising first information; the first information in the first signaling indicates whether the first signaling comprises second information.

In one embodiment, the first communication device 410 comprises at least one processor and at least one memory. The at least one memory comprises computer program codes; the at least one memory and the computer program codes are configured to be used in collaboration with the at least one processor. The first communication device 410 at least receives a first radio signal on a first radio resource; herein, the first radio signal comprises a first signaling, the first signaling comprising first information; whether the first signaling comprises second information is related to the first information, and the first information in the first signaling indicates whether the first node is in coverage.

In one embodiment, the first communication device 410 comprises a memory that stores a computer readable instruction program. The computer readable instruction program generates an action when executed by at least one processor. The action includes receiving a first radio signal on a first radio resource; herein, the first radio signal comprises a first signaling, the first signaling comprising first information; whether the first signaling comprises second information is related to the first information, and the first information in the first signaling indicates whether the first node is in coverage.

In one embodiment, the first communication device 410 comprises at least one processor and at least one memory. The at least one memory comprises computer program codes; the at least one memory and the computer program codes are configured to be used in collaboration with the at least one processor. The first communication device 410 at least receives a first radio signal on a first radio resource; herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

In one embodiment, the first communication device 410 comprises a memory that stores a computer readable instruction program. The computer readable instruction program generates an action when executed by at least one processor. The action includes receiving a first radio signal on a first radio resource; herein, the first radio signal comprises a first signaling, the first signaling comprising first information; whether the first signaling comprises second information is related to the first information, the first information in the first signaling indicates Q1 radio resource(s), and the first radio resource is one of the Q1 radio resource(s), Q1 being a positive integer.

In one embodiment, the first communication device 410 comprises at least one processor and at least one memory. The at least one memory comprises computer program codes; the at least one memory and the computer program codes are configured to be used in collaboration with the at least one processor. The first communication device 410 at least receives a first radio signal on a first radio resource; herein, the first radio signal comprises a first signaling, the first signaling comprising first information; the first information in the first signaling indicates whether the first signaling comprises second information.

In one embodiment, the first communication device 410 comprises a memory that stores a computer readable instruction program. The computer readable instruction program generates an action when executed by at least one processor. The action includes receiving a first radio signal on a first radio resource; herein, the first radio signal comprises a first signaling, the first signaling comprising first information; the first information in the first signaling indicates whether the first signaling comprises second information.

In one embodiment, at least one of the antenna 452, the transmitter 454, the multi-antenna transmission processor 458, the transmitting processor 468, the controller/processor 459, the memory 460, or the data source 467 is used to transmit the first radio signal in the present disclosure on the first radio resource in the present disclosure.

In one embodiment, at least one of the antenna 452, the receiver 454, the multi-antenna receiving processor 458, the receiving processor 456, the controller/processor 459, the memory 460, or the data source 467 is used to judge whether the first node is in coverage in the present disclosure.

In one embodiment, at least one of the antenna 452, the receiver 454, the multi-antenna receiving processor 458, the receiving processor 456, the controller/processor 459, the memory 460, or the data source 467 is used to receive the second signaling in the present disclosure.

In one embodiment, at least one of the antenna 452, the transmitter 454, the multi-antenna transmission processor 458, the transmitting processor 468, the controller/processor 459, the memory 460, or the data source 467 is used to perform channel coding on all bits in the first signaling in the present disclosure to obtain a second bit block.

In one embodiment, at least one of the antenna 452, the receiver 454, the multi-antenna receiving processor 458, the receiving processor 456, the controller/processor 459, the memory 460, or the data source 467 is used to receive the target-specific signal in the present disclosure.

In one embodiment, at least one of the antenna 452, the receiver 454, the multi-antenna receiving processor 458, the receiving processor 456, the controller/processor 459, the memory 460, or the data source 467 is used to receive the second radio signal in the present disclosure on the second radio resource in the present disclosure.

In one embodiment, at least one of the antenna 420, the receiver 418, the multi-antenna receiving processor 472, the receiving processor 470, the controller/processor 475, or the memory 476 is used to receive the first radio signal in the present disclosure on the first radio resource in the present disclosure.

In one embodiment, at least one of the antenna 420, the receiver 418, the multi-antenna receiving processor 472, the receiving processor 470, the controller/processor 475, or the memory 476 is used to perform channel coding on the second bit block in the present disclosure to obtain all bits in the first signaling the present disclosure.

In one embodiment, at least one of the antenna 420, the transmitter 418, the multi-antenna transmitting processor 471, the transmitting processor 416, the controller/processor 475, or the memory 476 is used to determine a transmission timing for transmitting a radio signal on the second radio resource in the present disclosure according to the second information in the first signaling in the present disclosure.

In one embodiment, at least one of the antenna 420, the transmitter 418, the multi-antenna transmitting processor 471, the transmitting processor 416, the controller/processor 475, or the memory 476 is used to transmit the second radio signal in the present disclosure on the second radio resource in the present disclosure.

### Embodiment 5

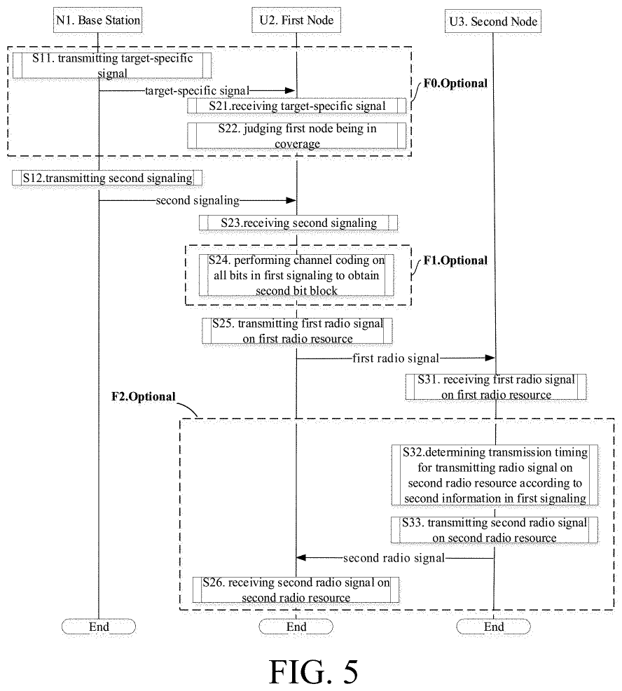

Embodiment 5 illustrates a flowchart of a radio signal transmission according to one embodiment in the present disclosure, as shown in FIG. 5. In FIG. 5, the base station N1 is a maintenance base station of a serving cell of the first node U2, and the second node U3 is a communication node for the first node U2 that transmits via Sidelink. In FIG. 5, steps in dotted-line-framed boxes F0, F1, F2 are optional.

The base station N1 transmits a target-specific signal in step S11; and transmits a second signaling in step S12.

The first node U2 receives a target-specific signal in step S21; judges that the first node U2 is in coverage in step S22; receives a second signaling in step S23; performs channel coding on all bits in a first signaling to obtain a second bit block in step S24; transmits a first radio signal on a first radio resource in step S25; and receives a second radio signal on a second radio resource in step S26.

The second node U3 receives a first radio signal on a first radio resource in step S31; determines a transmission timing for transmitting a radio signal on a second radio resource according to second information in a first signaling in step S32; and transmits a second radio signal on a second radio resource in step S33.

In Embodiment 5, the first radio signal comprises the first signaling, the first signaling comprising first information; the first radio resource is one of the Q1 radio resource(s), Q1 being a positive integer; the second signaling indicates Q2 radio resource(s), Q2 being a positive integer; the Q2 radio resource(s) comprises (comprise) the Q1 radio resource(s); the second bit block is used by the first node U2 for generating the first radio signal; the first node U2 judges whether the first node U2 is in coverage according to target-received quality of the target-specific signal; when the first signaling comprises second information, the second information indicates whether a reception timing of the first radio signal can be used by the second node U3 for determining a transmission timing for transmitting radio signals on the Q1 radio resources, Q1 being greater than 1; when the second information in the first signaling indicates that a reception timing of the first radio signal can be used by the second node U3 for determining a transmission timing on the Q1 radio resources, a reception timing of the first radio signal can be used by the second node U3 for determining a transmission timing of the second radio signal, otherwise a transmission timing of the second radio signal is unrelated to a reception timing of a radio signal transmitted by the first node; the second radio resource is one of the Q1 radio resources other than the first radio resource, Q1 being greater than 1.

In one embodiment, whether the first signaling comprises second information is related to the first information, and the first information in the first signaling indicates whether the first node U2 is in coverage.

In one embodiment, whether the first signaling comprises second information is related to the first information, the first information in the first signaling indicates Q1 radio resource(s), and the first radio resource is one of the Q1 radio resource(s), Q1 being a positive integer.

In one embodiment, the first information in the first signaling indicates whether the first signaling comprises second information.

In one embodiment, the first information in the first signaling indicates whether the first node U2 is in coverage; only when the first node U2 is in coverage, the first signaling may comprise the second information.

In one embodiment, the first information in the first signaling indicates whether the first node U2 is in coverage; when the first node U2 is not in coverage, the first signaling does not comprise the second information.

In one embodiment, the first information in the first signaling indicates whether the first node U2 is in coverage; when the first node U2 is not in coverage, the first signaling comprises the second information.

In one embodiment, the Q2 radio resource(s) comprises (comprise) the Q1 radio resource(s); and the first information in the first signaling indicates the Q1 radio resource(s).

In one embodiment, the first information in the first signaling is generated by the first node U2 at PHY; the first signaling comprises third information, and the third information in the first signaling is generated by the first node U2 at a higher layer; the first information in the first signaling indicates whether the first signaling comprises the second information.

In one embodiment, the second signaling is semi-statically configured.

In one embodiment, the second signaling is dynamically-configured.

In one embodiment, the second signaling is Broadcast.

In one embodiment, the second signaling is Groupcast.

In one embodiment, the second signaling is Unicast.

In one embodiment, the second signaling comprises all or part of a higher-layer signaling.

In one embodiment, the second signaling comprises all or part of an RRC-layer signaling.

In one embodiment, the second signaling is an RRC dedicated signaling.

In one embodiment, the second signaling comprises one or more fields of an RRC IE.

In one embodiment, the second signaling comprises all or part of a MAC-layer signaling.

In one embodiment, the second signaling comprises one or more fields of a MAC CE.

In one embodiment, the second signaling comprises one or more fields of a PHY layer.

In one embodiment, the second signaling comprises one or more fields of DCI.

In one embodiment, the second signaling comprises one or more fields in an MIB.

In one embodiment, the second signaling comprises one or more fields in an SIB.

In one embodiment, the second signaling comprises one or more fields in DCI format.

In one embodiment, the specific meaning of the DCI format can be found in 3GPP TS38. 212, section 7. 3. 1.

In one embodiment, the second signaling comprises a second sub-CB, the second sub-CB comprising a positive integer number of sequentially-arranged bits.

In one embodiment, the first signaling is obtained by all or part of bits of the second sub-CB sequentially through first-level scrambling, TB-level CRC Attachment, Channel Coding, Rate Matching, second-level scrambling, Modulation, Layer Mapping, Transform Precoding, Precoding, Mapping to Physical Resources, Baseband Signal Generation, and Modulation and Upconversion.

In one embodiment, the second signaling is obtained by the second sub-CB sequentially through CRC Attachment, Channel Coding, Rate Matching, Concatenation, scrambling, Modulation, Layer Mapping, Transform Precoding, Mapping to Physical Resources, Baseband Signal Generation, and Modulation and Upconversion.

In one embodiment, the second signaling is an output of all or part of bits of the second sub-CB sequentially through CB Segmentation, Channel Coding, Rate Matching, Concatenation, scrambling, Modulation, Layer Mapping, Spreading, transform precoding, precoding, Mapping to Physical Resources, Baseband Signal Generation, and Modulation and Upconversion.

In one embodiment, the second sub-CB is one CB.

In one embodiment, the second sub-CB is one TB.

In one embodiment, the second sub-CB is obtained by one TB through TB-level CRC attachment.

In one embodiment, the second sub-CB is one of CB(s) obtained by one TB sequentially through TB-level CRC Attachment, CB Segmentation and CB CRC Attachment.

In one embodiment, only the second sub-CB is used for generating the second signaling.

In one embodiment, there exists a CB other than the second sub-CB also being used for generating the second signaling.

In one embodiment, the second signaling explicitly indicates the Q2 radio resource(s), Q2 being a positive integer.

In one embodiment, the second signaling implicitly indicates the Q2 radio resource(s), Q2 being a positive integer.

In one embodiment, (an) index(es) of the Q2 radio resource(s) is(are) sequentially radio resource #0, radio resource #1, . . . , and radio resource #(Q2-1).

In one embodiment, the second signaling indicating the Q2 radio resource(s) means that the second signaling comprises (an) index(es) of the Q2 radio resource(s).

In one embodiment, the second signaling indicates a time-frequency resource position of any of the Q2 radio resource(s).

In one embodiment, the second signaling comprises Q2 piece(s) of second-type sub-information, each of the Q2 piece(s) of second-type sub-information respectively corresponds to the Q2 radio resource(s).

In one embodiment, any of the Q2 piece(s) of second sub-information indicates an index of a corresponding radio resource in the Q2 radio resource(s).

In one embodiment, any of the Q2 piece(s) of second sub-information indicates a time-frequency resource position of a corresponding radio resource in the Q2 radio resource(s).

In one embodiment, the second signaling comprises Q2 fourth-type field(s), each of the Q2 fourth-type field(s) consists of a positive integer number of bit(s); each of the Q2 fourth-type field(s) respectively corresponds to the Q2 radio resource(s).

In one embodiment, any of the Q2 fourth-type field(s) indicates an index of a corresponding radio resource in the Q2 radio resource(s).

In one embodiment, any of the Q2 fourth-type field(s) indicates an index of a corresponding one of the Q2 radio resource(s) in the Q2 radio resource(s).

In one embodiment, any of the Q2 fourth-type field(s) indicates a time-frequency resource position of a corresponding radio resource in the Q2 radio resource(s).

In one embodiment, the second signaling comprises Q2 fourth-type field(s), each of the Q2 fourth-type field(s) consists of a positive integer number of bit(s); at least one of the Q2 fourth-type field(s) indicates an index of a corresponding one of the Q2 radio resource(s) in the Q2 radio resource(s), Q2 being a positive integer.

In one embodiment, the second signaling comprises Q2 fourth-type field(s), each of the Q2 fourth-type field(s) consists of a positive integer number of bit(s); at least one of the Q1 fourth-type field(s) in the Q2 fourth-type field(s) indicates a corresponding radio resource in the Q1 radio resource(s), Q1 and Q2 being positive integers.

In one embodiment, for each of the Q2 radio resource(s), the second signaling indicates a corresponding center frequency and BWP.

In one embodiment, the Q2 radio resource(s) comprises (comprise) a reference radio resource, and the second signaling indicates a center frequency and BWP of the reference radio resource.

In one subembodiment of the above embodiment, for any radio resource in the Q2 radio resource(s) other than the reference radio resource, the second signaling indicates a difference value between its corresponding center frequency and a center frequency of the reference radio resource.

In one embodiment, the center frequency is an Absolute Radio Frequency Channel Number (AFCN).

In one embodiment, the center frequency is positive integral multiple of 100 kHz.

In one embodiment, for each of the Q2 radio resource(s), the second signaling indicates a lowest frequency point and a highest frequency point of its occupied frequency-domain resources.

In one embodiment, for each of the Q2 radio resource(s), the second signaling indicates a lowest frequency point and a BWP of its occupied frequency-domain resources.

In one embodiment, the second information indicates whether a reception timing of the first radio signal can be used for (a) transmission timing(s) for transmitting (a) radio signal(s) on the Q1 radio resource(s).

In one embodiment, the second information indicates whether a reception timing for receiving the first radio signal can be used for a transmission timing for transmitting a radio signal on the third radio resource in the Q1 radio resource(s).

In one embodiment, the second information indicates whether a reception timing obtained by the first radio resource receives the first radio signal can be used for (a) transmission timing(s) for transmitting (a) radio signal(s) on the Q1 radio resource(s).

In one embodiment, the second information indicates whether a reception timing of the first radio signal can be used for a transmission timing for transmitting a radio signal on the third radio resource in the Q1 radio resource(s).

In one embodiment, the second information indicates whether a reception timing obtained by the first radio resource receives the first radio signal can be used for a transmission timing for transmitting a radio signal on the third radio resource in the Q1 radio resource(s).

In one embodiment, a receiver of the first radio signal determines (a) transmission timing(s) for transmitting (a) radio signal(s) on the Q1 radio resource(s) according to a reception timing of the first radio signal.

In one embodiment, a receiver of the first radio signal determines a transmission timing for transmitting a radio signal on the third radio resource in the Q1 radio resource(s) according to a reception timing of the first radio signal.

In one embodiment, a receiver of the first radio signal determines a transmission timing for transmitting a radio signal on the third radio resource in the Q1 radio resource(s) according to a reception timing for receiving the first radio signal on the first radio resource.

In one embodiment, a receiver of the first radio signal determines (a) transmission timing(s) for transmitting (a) radio signal(s) on the Q1 radio resource(s) according to a reception timing of the first radio signal and the second information.

In one embodiment, a receiver of the first radio signal determines a transmission timing for transmitting a radio signal on the third radio resource in the Q1 radio resource(s) according to a reception timing of the first radio signal and the second information.

In one embodiment, a receiver of the first radio signal determines a transmission timing for transmitting a radio signal on the third radio resource in the Q1 radio resource(s) according to a reception timing for receiving the first radio signal on the first radio resource and the second information.

In one embodiment, the second information indicates (a) time offset(s) between (a) transmission timing(s) for transmitting (a) radio signal(s) on the Q1 radio resource(s) and a reception timing obtained by receiving the first radio signal.

In one embodiment, the second information indicates a time offset between a transmission timing for transmitting a radio signal on the third radio resource in the Q1 radio resource(s) and a reception timing obtained by receiving the first radio signal.

In one embodiment, the transmission timing is later than the reception timing.

In one embodiment, the transmission timing is the reception timing plus one time offset.

In one embodiment, the time offset is a difference value between the transmission timing and the reception timing.

In one embodiment, the time offset is fixed.

In one embodiment, the time offset is determined by the receiver of the first radio signal itself.

In one embodiment, the time offset is configured.

In one embodiment, the time offset comprises a positive integer number of time interval(s).

In one embodiment, the time interval comprises a positive integer number of ms(s).

In one embodiment, the time interval comprises a positive integer number of μs(s).

In one embodiment, the time interval comprises a positive integer number of sampling point(s).

In one embodiment, the time offset is measured by s.

In one embodiment, the time offset is measured by ms.

In one embodiment, the time offset is measured by μs.

In one embodiment, the time offset is measured by sampling point.

In one embodiment, the transmission timing is used for transmitting a radio signal on the third-type channel in the present disclosure.

In one embodiment, the transmission timing is used for transmitting a radio signal on the second-type channel in the present disclosure.

In one embodiment, the transmission timing is used for transmitting a radio signal on the first-type channel in the present disclosure.

In one embodiment, the transmission timing is used for transmitting the third-type signal in the present disclosure.

In one embodiment, the transmission timing is used for transmitting the second-type signal in the present disclosure.

In one embodiment, the transmission timing is used for transmitting the first-type signal in the present disclosure.

In one embodiment, a receiver of the synchronization reference determines a reception timing according to a reception timing of the synchronization reference.

In one embodiment, the second information is explicitly indicated, that is, the second information is the second bit string.

In one embodiment, the second information is implicitly indicates, that is, the second information is used for generating one or more of a scrambling sequence for scrambling the first CB, a TB-level CRC performed on the first CB, a CB-level CRC performed on the first CB, a scrambling sequence for scrambling the first sub-CB, a TB-level CRC performed on the first sub-CB, and a CB-level CRC performed on the first sub-CB.

In one embodiment, the second radio resource is determined out of the Q1 radio resource(s).

In one embodiment, Q1 radio resource(s) is(are) candidate resource(s) for transmitting the second radio signal.

In one embodiment, the Q1 radio resource(s) comprises (comprise) the second radio resource.

In one embodiment, the second radio resource is one of Q1 radio resource(s).

In one embodiment, a second node in the present disclosure determines the second radio resource by itself.

In one embodiment, a second node in the present disclosure determines the second radio resource out of the Q1 radio resource(s) by itself.

In one embodiment, a first node in the present disclosure is configured to select the second radio resource out of the Q1 radio resource(s).

In one embodiment, selecting the second radio resource out of the Q1 radio resource(s) is related to a received first radio signal.

In one embodiment, selecting the second radio resource out of the Q1 radio resource(s) is related to a received first signaling.

In one embodiment, selecting the second radio resource out of the Q1 radio resource(s) is related to received first information.

In one embodiment, a second node in the present disclosure selects the second radio resource out of the Q1 radio resource(s) according to its received first radio signal.

In one embodiment, the third radio resource is the second radio resource.

In one embodiment, the second radio resource is the same with the first radio resource.

In one embodiment, the second radio signal comprises the third-type signal in the present disclosure.

In one embodiment, the second radio signal comprises the second-type signal in the present disclosure.

In one embodiment, the second radio signal comprises the first-type signal in the present disclosure.

In one embodiment, the second radio signal is transmitted on the third-type channel in the present disclosure.

In one embodiment, the second radio signal is transmitted on the second-type channel in the present disclosure.

In one embodiment, the second radio signal is transmitted on the first-type channel in the present disclosure.

In one embodiment, the second radio signal comprises a third CB, the third CB comprising a positive integer number of sequentially-arranged bit(s).

In one embodiment, the third CB comprises one or more fields in an MIB.

In one embodiment, the third CB comprises one or more fields in an MIB-SL.

In one embodiment, the third CB comprises one or more fields in an MIB-V2X-SL.

In one embodiment, the third CB comprises one or more fields in an SIB.

In one embodiment, the second radio signal is obtained by all or part of bits of the third CB sequentially through first-level scrambling, TB-level Cyclic Redundancy Check (CRC) Attachment, Channel Coding, Rate Matching, second-level scrambling, Modulation, Layer Mapping, Transform Precoding, Precoding, Mapping to Physical Resources, Baseband Signal Generation, and Modulation and Upconversion.

In one embodiment, the second radio signal is obtained by the third sub-CB sequentially through CRC Attachment, Channel Coding, Rate Matching, Concatenation, scrambling, Modulation, Layer Mapping, Transform Precoding, Mapping to Physical Resources, Baseband Signal Generation, and Modulation and Upconversion.

In one embodiment, the second radio signal is obtained by the third sub-CB sequentially through CRC Attachment, Channel Coding, Rate Matching, Concatenation, scrambling, Modulation, Layer Mapping, Transform Precoding, Mapping to Physical Resources, Baseband Signal Generation, and Modulation and Upconversion.

In one embodiment, the second radio signal is an output of all or part of bits of the third sub-CB sequentially through CB Segmentation, Channel Coding, Rate Matching, Concatenation, scrambling, Modulation, Layer Mapping, Spreading, transform precoding, precoding, Mapping to Physical Resources, Baseband Signal Generation, and Modulation and Upconversion.

In one embodiment, the third CB is one CB.

In one embodiment, the third CB is one TB.

In one embodiment, the third CB is obtained by one TB through TB-level CRC attachment.

In one embodiment, the third CB is one of CB(s) obtained by one TB sequentially through TB-level CRC Attachment, CB Segmentation and CB CRC Attachment.

In one embodiment, only the third CB is used for generating the second radio signal.

In one embodiment, there exists a CB other than the third CB also being used for generating the second radio signal.

In one embodiment, a transmission timing of the second radio signal is a sum of a reception timing of the first radio signal and a first time offset.

In one embodiment, a transmission timing for transmitting the second radio signal on the second radio resource is a sum of a reception timing for receiving the first radio signal on the first radio resource and a first time offset.

In one embodiment, the second node determines a transmission timing of the second radio signal by itself according to a reception timing of the first radio signal.

In one embodiment, the second information in the first signaling indicates a difference value between a transmission timing of the second radio signal and a reception timing of the first radio signal.

In one embodiment, the second information in the first signaling indicates the first time offset.

In one embodiment, the first time offset is a difference value between a transmission timing of the second radio signal and a reception timing of the first radio signal.

In one embodiment, when the second information in the first signaling indicates a reception timing of the first radio signal can be used for determining a transmission timing of the second radio signal, a transmission timing of the second radio signal is a sum of a reception timing of the first radio signal and the first time offset.

In one embodiment, when the second information in the first signaling indicates the first time offset, a transmission timing of the second radio signal is a sum of a reception timing of the first radio signal and the first time offset.

In one embodiment, when the second information in the first signaling indicates the second radio resource and the first time offset, a transmission timing of the second radio signal is a sum of a reception timing of the first radio signal and the first time offset.

In one embodiment, when the first information in the first signaling indicates the second radio resource, the second information indicates the first time offset, and a transmission timing of the second radio signal is a sum of a reception timing of the first radio signal and the first time offset.

In one embodiment, when the second information in the first signaling indicates a timing of a first radio signal cannot be used for determining a transmission timing for transmitting the second radio signal on the second radio resource, a transmission timing of the second radio signal is unrelated to a reception timing of the first radio signal.

In one embodiment, when the first signaling does not comprise the second information, a transmission timing of the second radio signal is unrelated to a reception timing of the first radio signal.

In one embodiment, the second radio resource is different from the first radio resource.

In one embodiment, the second radio resource is different from the first radio resource in frequency domain.

In one embodiment, the second radio resource is different from the first radio resource in time domain.

In one embodiment, the second radio resource is different from the first radio resource in space domain.

In one embodiment, a transmission timing of the second radio signal is later than a reception timing of the first radio signal.

In one embodiment, a transmission timing of the second radio signal is a reception timing of the first radio signal plus a time offset.

In one embodiment, the first time offset is fixed.

In one embodiment, the first time offset is determined by the second node itself.

In one embodiment, the first time offset is configured.

In one embodiment, the first time offset comprises a positive integer number of time interval(s).

In one embodiment, the first time offset is measured by s.

In one embodiment, the first time offset is measured by ms.

In one embodiment, the first time offset is measured by μs.

In one embodiment, the first time offset is measured by sampling point.

In one embodiment, the first node U2 is a UE.

In one embodiment, the first node U2 is a relay node.

In one embodiment, the first node U2 comprises a Synchronization Reference User Equipment (SyncRefUE).

In one embodiment, the specific meaning of the SyncRefUE can be found in 3GPP TS36. 331, section 5. 10. 4.

In one embodiment, the first node U2 comprises a SynRefUE In-Coverage.

In one embodiment, the first node U2 comprises a SynRefUE Out-of-Coverage.

In one embodiment, the second node U3 is a UE.

In one embodiment, the second node U3 is a relay node.

In one embodiment, the second node U3 comprises a SyncRefUE.

In one embodiment, the second node U3 comprises a SynRefUE In-Coverage.

In one embodiment, the second node U3 comprises a SynRefUE Out-of-Coverage.

In one embodiment, when the first node U2 is In-Coverage, the first node U2 receives the second signaling.

In one embodiment, the base station N1 comprises the GNSS.

In one embodiment, the base station N1 comprises a cell.

In one embodiment, the base station N1 comprises a SyncRefUE.

In one embodiment, the base station N1 comprises a SynRefUE In-Coverage.

In one embodiment, the base station N1 comprises a SynRefUE Out-of-Coverage.

### Embodiment 6

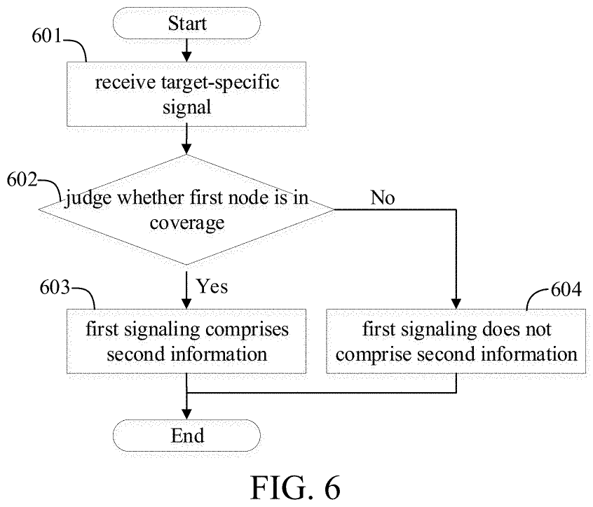

Embodiment 6 illustrates a flowchart of determining whether a first signaling comprises second information according to one embodiment of the present disclosure, as shown in FIG. 6.

In Embodiment 6, a first node in the present disclosure receives a target-specific signal, and judges whether the first node is in coverage according to target received quality of the target-specific signal; when the first node is in coverage, a first signaling in the present disclosure comprises second information in the present disclosure; when the first node is out of coverage, the first signaling does not comprise the second information.

In one embodiment, the first information indicates whether the first node is in coverage.

In one embodiment, the first information comprises an In-Coverage Indicator.

In one embodiment, the first information comprises an In-Coverage field in an Information Element (IE) MasterinformationBlock-SL, and the specific meaning of the IE MasterinformationBlock-SL can be found in 3GPP TS36. 331, section 6. 5. 2.

In one embodiment, the first information comprises an In-Coverage field in an Information Element (IE) MasterinformationBlock-SL-V2X, and the specific meaning of the IE MasterinformationBlock-SL-V2X can be found in 3GPP TS36. 331, section 6. 5. 2.

In one embodiment, when the first node is in coverage, the first information is a Boolean value “TRUE”.

In one embodiment, when the first node is out of coverage, the first information is a Boolean value “FALSE”.

In one embodiment, when the first information indicates that the first node is in coverage, the first signaling comprises the second information.

In one embodiment, when the first information indicates that the second node is out of coverage, the first signaling does not comprise the second information.

### Embodiment 7

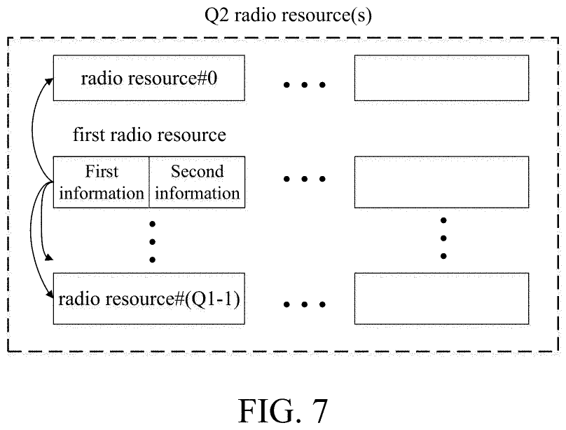

Embodiment 7 illustrates a schematic diagram of first information indicating Q1 radio resource(s) according to one embodiment of the present disclosure, as shown in FIG. 7.

In Embodiment 7, Q2 radio resource(s) in the present disclosure comprises (comprise) Q1 radio resource(s) in the present disclosure; (an) index(es) of the Q1 radio resource(s) in the Q2 radio resource(s) is(are) respectively radio resource #0, radio resource #1, . . . , and radio resource #(Q1-1); a first radio resource in the present disclosure is one of the Q1 radio resource(s); a second signaling in the present disclosure indicates the Q2 radio resource(s); first information in a first signaling in the present disclosure indicates the Q1 radio resource(s); a first radio signal in the present disclosure is transmitted on the first radio resource; the first radio signal comprises the first signaling, the first signaling comprising the first information, Q2 and Q1 both being positive integers, Q1 being no greater than Q2.

In one embodiment, each of the Q2 radio resource(s) respectively belongs to a positive integer number of carrier(s) in frequency domain.

In one embodiment, each of the Q2 radio resource(s) respectively belongs to Q2 carrier(s) in frequency domain.

In one embodiment, each of the Q2 radio resource(s) respectively belongs to a positive integer number of BWP(s) in frequency domain.

In one embodiment, each of the Q2 radio resource(s) respectively belongs to Q1 BWP(s) in frequency domain.

In one embodiment, each of the Q2 radio resource(s) belongs to a same carrier in frequency domain.

In one embodiment, each of the Q2 radio resource(s) respectively belongs to Q2 BWP(s) in a same carrier.

In one embodiment, each of the Q2 radio resources respectively belongs to Q2 BWPs, at least two of the Q2 BWPs belong to different carriers, Q2 being a positive integer greater than 1.

In one embodiment, each of the Q2 radio resources respectively belongs to Q2 BWPs, at least two of the Q2 BWPs belong to a same carrier, Q2 being a positive integer greater than 1.

In one embodiment, any two of the Q2 carriers are orthogonal in frequency domain (that is, non-overlapping), Q1 being a positive integer greater than 1.

In one embodiment, any two of the Q2 BWPs are orthogonal in frequency domain, Q1 being a positive integer greater than 1.

In one embodiment, each of the Q2 radio resource(s) respectively belongs to a positive integer number of radio frame(s) in time domain.

In one embodiment, each of the Q2 radio resource(s) respectively belongs to Q2 radio frame(s) in time domain.

In one embodiment, each of the Q2 radio resource(s) respectively belongs to a positive integer number of subframe(s) in time domain.

In one embodiment, each of the Q2 radio resource(s) respectively belongs to Q2 subframe(s) in time domain.

In one embodiment, any of the Q2 subframe(s) comprises a positive integer number of slot(s).

In one embodiment, each of the Q2 radio resource(s) respectively belongs to a positive integer number of slot(s) in time domain.

In one embodiment, each of the Q2 radio resource(s) respectively belongs to Q2 slot(s) in time domain.

In one embodiment, any of the Q2 slot(s) comprises a positive integer number of multicarrier symbol(s).

In one embodiment, each of the Q2 radio resource(s) respectively belongs to a positive integer number of sub-slot(s) in time domain.

In one embodiment, each of the Q2 radio resource(s) respectively belongs to Q2 sub-slot(s) in time domain.

In one embodiment, each of the Q2 radio resource(s) respectively belongs to a positive integer number of Mini-slot(s) in time domain.

In one embodiment, each of the Q2 radio resource(s) respectively belongs to Q2 Mini-slot(s) in time domain.

In one embodiment, any of the Q2 Mini-slot(s) comprises a positive integer number of multicarrier symbol(s).

In one embodiment, each of the Q2 radio resource(s) respectively belongs to a positive integer number of multicarrier symbol(s) in time domain.

In one embodiment, each of the Q2 radio resource(s) respectively belongs to Q2 multicarrier symbol(s) in time domain.

In one embodiment, any two of the Q2 radio frames are orthogonal in time domain (that is, non-overlapping).

In one embodiment, any two of the Q2 sub-frames are orthogonal in time domain.

In one embodiment, any two of the Q2 slots are orthogonal in time domain.

In one embodiment, any two of the Q2 Mini-slots are orthogonal in time domain.

In one embodiment, any two of the Q2 multicarrier symbols are orthogonal in time domain.

In one embodiment, each of the Q2 radio resource(s) respectively belongs to Q2 spatial parameter group(s), and any of the Q2 spatial parameter group(s) comprises a positive integer number of spatial parameter(s).

In one embodiment, each of the Q1 radio resource(s) respectively belongs to a positive integer number of carrier(s) in frequency domain.

In one embodiment, each of the Q1 radio resource(s) respectively belongs to Q1 carrier(s) in frequency domain.

In one embodiment, each of the Q1 radio resource(s) respectively belongs to a positive integer number of BWP(s).

In one embodiment, each of the Q1 radio resource(s) respectively belongs to Q1 BWP(s).

In one embodiment, each of the Q1 radio resource(s) belongs to a same carrier in frequency domain.

In one embodiment, each of the Q1 radio resource(s) respectively belongs to Q1 BWP(s) in a same carrier in frequency domain.

In one embodiment, each of the Q1 radio resources respectively belongs to Q1 BWPs, at least two of the Q1 BWPs belong to different carriers, Q1 being a positive integer greater than 1.

In one embodiment, each of the Q1 radio resources respectively belongs to Q1 BWPs, at least two of the Q1 BWPs belong to a same carrier, Q1 being a positive integer greater than 1.

In one embodiment, any two of the Q1 carriers are orthogonal in frequency domain (that is, non-overlapping), Q1 being a positive integer greater than 1.

In one embodiment, any two of the Q1 BWPs are orthogonal in frequency domain, Q1 being a positive integer greater than 1.

In one embodiment, each of the Q1 radio resource(s) respectively belongs to a positive integer number of radio frame(s) in time domain.

In one embodiment, each of the Q1 radio resource(s) respectively belongs to Q1 radio frame(s) in time domain.

In one embodiment, each of the Q1 radio resource(s) respectively belongs to a positive integer number of subframe(s) in time domain.

In one embodiment, each of the Q1 radio resource(s) respectively belongs to Q1 subframe(s) in time domain.

In one embodiment, any of the Q1 subframe(s) comprises a positive integer number of slot(s).

In one embodiment, each of the Q1 radio resource(s) respectively belongs to a positive integer number of slot(s) in time domain.

In one embodiment, each of the Q1 radio resource(s) respectively belongs to Q1 slot(s) in time domain.

In one embodiment, any of the Q1 slot(s) comprises a positive integer number of multicarrier symbol(s).

In one embodiment, each of the Q1 radio resource(s) respectively belongs to a positive integer number of sub-slot(s) in time domain.

In one embodiment, each of the Q1 radio resource(s) respectively belongs to Q1 sub-slot(s) in time domain.

In one embodiment, each of the Q1 radio resource(s) respectively belongs to a positive integer number of Mini-slot(s) in time domain.

In one embodiment, each of the Q1 radio resource(s) respectively belongs to Q1 Mini-slot(s) in time domain.

In one embodiment, any of the Q1 Mini-slot(s) comprises a positive integer number of multicarrier symbol(s).

In one embodiment, each of the Q1 radio resource(s) respectively belongs to a positive integer number of multicarrier symbol(s) in time domain.

In one embodiment, each of the Q1 radio resource(s) respectively belongs to Q1 multicarrier symbol(s) in time domain.

In one embodiment, any two of the Q1 radio frames are orthogonal in time domain (that is, non-overlapping).

In one embodiment, any two of the Q1 sub-frames are orthogonal in time domain.

In one embodiment, any two of the Q1 slots are orthogonal in time domain.

In one embodiment, any two of the Q1 Mini-slots are orthogonal in time domain.

In one embodiment, any two of the Q1 multicarrier symbols are orthogonal in time domain.

In one embodiment, each of the Q1 radio resource(s) respectively belongs to Q1 spatial parameter group(s), and any of the Q1 spatial parameter group(s) comprises a positive integer number of spatial parameter(s).

In one embodiment, the Q1 radio resource(s) is(are) selected out of the Q2 radio resource(s).

In one embodiment, how to select the Q1 radio resource(s) out of the Q2 radio resource(s) is implementation related (that is, there is no need to be standardized).

In one embodiment, how to select the Q1 radio resource(s) out of the Q2 radio resource(s) is determined by the first node itself.

In one embodiment, the first signaling indicates (an) index(es) of the Q1 radio resource(s) in the Q2 radio resource(s).

In one embodiment, for each of the Q1 radio resource(s), the first signaling indicates a corresponding center frequency and a BWP.

In one subembodiment of the above embodiment, for the first radio resource, the first signaling indicates a corresponding center frequency.

In one subembodiment of the above embodiment, for any of the Q1 radio resource(s) other than the first radio resource, the first signaling indicates a difference value between its corresponding center frequency and a center frequency of the first radio resource.

In one embodiment, for each of the Q1 radio resource(s), the first signaling indicates a corresponding center frequency and a BWP.

In one embodiment, the Q1 radio resource(s) comprises (comprise) a reference radio resource, and the first signaling indicates a center frequency and a BWP of the reference radio resource.

In one embodiment, the center frequency is an Absolute Radio Frequency Channel Number (AFCN).

In one embodiment, the center frequency is positive integral multiple of 100 kHz.

In one embodiment, for each of the Q1 radio resource(s), the first signaling indicates a lowest frequency point and a highest frequency point of its occupied frequency-domain resources.

In one embodiment, for each radio resource in the Q1 radio resource(s), the first signaling indicates a lowest frequency point and a BWP of its occupied frequency-domain resources.

In one embodiment, a transmitter of the second signaling is a Synchronization Reference Source of the first node.

In one embodiment, the synchronization reference source of the first node comprises at least one of the GNSS, a Cell and a SyncRefUE.

### Embodiment 8

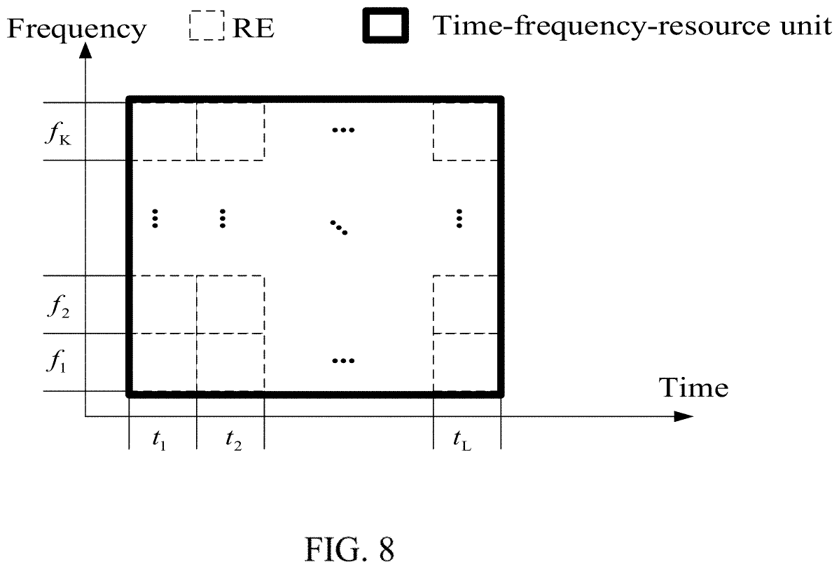

Embodiment 8 illustrates a schematic diagram of a time-frequency resource unit according to one embodiment of the present disclosure, as shown in FIG. 8. In FIG. 8, a dotted small box represents a Resource Element (RE), and a heavy-line box represents a time-frequency resource unit. In FIG. 8, a time-frequency resource unit occupies K subcarrier(s) in frequency domain, and L multicarrier symbol(s) in time domain, K and L being positive integers. In FIG. 8, t1, t2, . . . , and tL represent(s) the L symbol(s), and f1, f2, and fK represent(s) the K subcarrier(s).

In Embodiment 8, a time-frequency resource unit occupies K subcarrier(s) in frequency domain, and L multicarrier symbol(s) in time domain, K and L being positive integers.

In one embodiment, the K is equal to 12.

In one embodiment, the K is equal to 72.

In one embodiment, the K is equal to 127.

In one embodiment, the K is equal to 240.

In one embodiment, the L is equal to 1.

In one embodiment, the L is equal to 2.

In one embodiment, the L is not greater than 14.

In one embodiment, any of the L multicarrier symbol(s) is at least one of a Frequency Division Multiple Access (FDMA) symbol, an Orthogonal Frequency Division Multiplexing (OFDM) symbol, a Single-Carrier Frequency Division Multiple Access (SC-FDMA), a Discrete Fourier Transform Spread Orthogonal Frequency Division Multiplexing (DFTS-OFDM) symbol, a Filter Bank Multi-Carrier (FBMC) symbol, and an Interleaved Frequency Division Multiple Access (IFDMA) symbol.

In one embodiment, the time-frequency resource unit comprises R RE(s), R being a positive integer.

In one embodiment, the time-frequency resource unit consists of R RE(s), R being a positive integer.

In one embodiment, any of the R RE(s) occupies a multicarrier symbol in time domain and a subcarrier in frequency domain.

In one embodiment, an SCS of the one RE is measured by Hertz (Hz).

In one embodiment, an SCS of the one RE is measured by Kilohertz (kHz).

In one embodiment, an SCS of the one RE is measured by Megahertz (MHz).

In one embodiment, a symbol length of a multicarrier symbol of the one RE is measured by sampling point.

In one embodiment, a symbol length of a multicarrier symbol of the one RE is measured by μs.

In one embodiment, a symbol length of a multicarrier symbol of the one RE is measured by ms.

In one embodiment, an SCS of the one RE is at least one of 1.25 kHz, 2.5 kHz, 5 kHz, 15 kHz, 30 kHz, 60 kHz, 120 kHz and 240 kHz.

In one embodiment, a product of the K and the L of the time-frequency resource unit is no less than the R.

In one embodiment, the time-frequency resource unit does not comprise an RE allocated to a Guard Period (GP).

In one embodiment, the time-frequency resource unit does not comprise an RE allocated to a Reference Signal (RS).

In one embodiment, the time-frequency resource unit does not comprise an RE allocated to the first-type signal in the present disclosure.

In one embodiment, the time-frequency resource unit does not comprise an RE allocated to the first-type channel in the present disclosure.

In one embodiment, the time-frequency resource unit does not comprise an RE allocated to the second-type signal in the present disclosure.

In one embodiment, the time-frequency resource unit does not comprise an RE allocated to the second-type channel in the present disclosure.

In one embodiment, the time-frequency resource unit does not comprise an RE allocated to the third-type signal in the present disclosure.

In one embodiment, the time-frequency resource unit does not comprise an RE allocated to the third-type channel in the present disclosure.

In one embodiment, the time-frequency resource unit comprises a positive integer number of Resource Block(s) (RB).

In one embodiment, the time-frequency resource unit belongs to one RB.

In one embodiment, the time-frequency resource unit is equal to one RB in frequency domain.

In one embodiment, the time-frequency resource unit comprises 6 RBs in frequency domain.

In one embodiment, the time-frequency resource unit comprises 20 RBs in frequency domain.

In one embodiment, the time-frequency resource unit comprises a positive integer number of PRB(s)

In one embodiment, the time-frequency resource unit belongs to one PRB.

In one embodiment, the time-frequency resource unit is equal to one PRB in frequency domain.

In one embodiment, the time-frequency resource unit comprises a positive integer number of Virtual Resource Block(s) (VRB).

In one embodiment, the time-frequency resource unit belongs to one VRB.

In one embodiment, the time-frequency resource unit is equal to one VRB in frequency domain.

In one embodiment, the time-frequency resource unit comprises a positive integer number of PRB pair(s)

In one embodiment, the time-frequency resource unit belongs to one PRB pair.

In one embodiment, the time-frequency resource unit is equal to one PRB pair in frequency domain.

In one embodiment, the time-frequency resource unit comprises a positive integer number of frame(s).

In one embodiment, the time-frequency resource unit belongs to one frame.

In one embodiment, the time-frequency resource unit is equal to one frame in time domain.

In one embodiment, the time-frequency resource unit comprises a positive integer number of subframe(s).

In one embodiment, the time-frequency resource unit belongs to one sub frame.

In one embodiment, the time-frequency resource unit is equal to one subframe in time domain.

In one embodiment, the time-frequency resource unit comprises a positive integer number of slot(s).

In one embodiment, the time-frequency resource unit belongs to one slot.

In one embodiment, the time-frequency resource unit is equal to one slot in time domain.

In one embodiment, the time-frequency resource unit comprises a positive integer number of Symbol(s).

In one embodiment, the time-frequency resource unit belongs to one Symbol.

In one embodiment, the time-frequency resource unit is equal to one Symbol in time domain.

In one embodiment, the time-frequency resource unit belongs to the first-type signal in the present disclosure.

In one embodiment, the time-frequency resource unit belongs to the second-type signal in the present disclosure.

In one embodiment, the time-frequency resource unit belongs to the third-type signal in the present disclosure.

In one embodiment, the time-frequency resource unit belongs to the first-type channel in the present disclosure.

In one embodiment, the time-frequency resource unit belongs to the second-type channel in the present disclosure.

In one embodiment, the time-frequency resource unit belongs to the third-type channel in the present disclosure.

In one embodiment, the time-frequency resource unit comprise an RE allocated to a GP.

### Embodiment 9

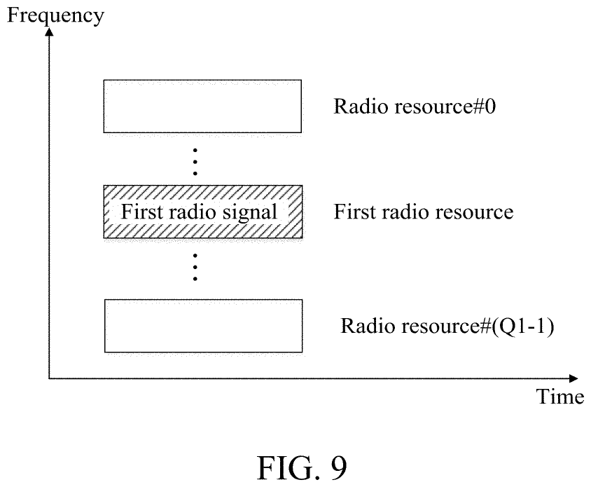

Embodiment 9 illustrates a schematic diagram of a relationship of Q1 radio resource(s) according to one embodiment of the present disclosure, as shown in FIG. 9. In FIG. 9, each rectangle represents one of the Q1 radio resource(s) in the present disclosure, a slash-filled rectangle represents a first radio resource in the present disclosure, Q1 being a positive integer.

In Embodiment 9, first information comprised in a first signaling in the present disclosure indicates the Q1 radio resource(s); each of the Q1 radio resource(s) respectively comprises a positive integer number of time-frequency resource unit(s); the first radio resource is one of the Q1 radio resource(s); a first radio signal in the present disclosure is transmitted on the first radio resource, Q1 being a positive integer.

In one embodiment, the radio resource comprises a positive integer number of time-frequency resource unit(s).

In one embodiment, the radio resource belongs to a Carrier.

In one embodiment, the radio resource belongs to a BWP.

In one embodiment, the radio resource comprises a BWP.

In one embodiment, the radio resource comprises a positive integer number of BWP(s).

In one embodiment, the radio resource comprises an UL multicarrier symbol and a DL multicarrier symbol.

In one embodiment, the radio resource comprises an UL multicarrier symbol, a DL multicarrier symbol and a Sidelink multicarrier symbol.

In one embodiment, the radio resource comprises an UL multicarrier symbol.

In one embodiment, the radio resource only comprises a DL multicarrier symbol.

In one embodiment, the radio resource only comprises an UL multicarrier symbol.

In one embodiment, the radio resource only comprises a Sidelink multicarrier symbol.

In one embodiment, the radio resource comprises a positive integer number of time unit(s) in time domain.

In one embodiment, the time unit is at least one of a radio frame, a slot, a subframe, a sub-slot, a mini-slot and a multicarrier symbol.

In one embodiment, the radio resource comprises a positive integer number of frequency unit(s) in time domain.

In one embodiment, the frequency unit is at least one of a carrier, a BWP, a PRB, a VRB, an RB, and a subcarrier.

In one embodiment, the radio resource comprises a positive integer number of the time-frequency resource unit(s).

In one embodiment, at least two the time-frequency resource units comprised in the radio resource are orthogonal in time domain.

In one embodiment, at least two the time-frequency resource units comprised in the radio resource are orthogonal in frequency domain.

In one embodiment, at least two the time-frequency resource units comprised in the radio resource are consecutive in time domain.

In one embodiment, at least two the time-frequency resource units comprised in the radio resource are discrete in time domain.

In one embodiment, at least two the time-frequency resource units comprised in the radio resource are consecutive in frequency domain.

In one embodiment, at least two the time-frequency resource units comprised in the radio resource are discrete in frequency domain.

In one embodiment, the radio resource comprises consecutive frequency-domain resources in frequency domain.

In one embodiment, the radio resource comprises discrete frequency-domain resources in frequency domain.

In one embodiment, the radio resource comprises consecutive time domain resources in time domain.

In one embodiment, the radio resource comprises discrete time-domain resources in time domain.

In one embodiment, the first information explicitly indicates the Q1 radio resource(s).

In one embodiment, the first information implicitly indicates the Q1 radio resource(s).

In one embodiment, the first information in the present disclosure comprises a first bitmap, and the first bitmap comprises Q2 bit(s), each of the Q2 bit(s) respectively corresponds to Q2 radio resource(s) in the present disclosure, Q2 being a positive integer.

In one embodiment, the first information in the present disclosure comprises a first bitmap, the first bitmap comprises Q2 bit(s), one bit in the first bitmap corresponds to one of the Q2 radio resource(s) in the present disclosure, Q2 being a positive integer.

In one embodiment, the first information in the present disclosure indicating the Q1 radio resource(s) means that a given bit is any of the Q2 bit(s) in the first bitmap, the given bit is used for corresponding to a given radio resource in the Q2 radio resource(s), when the given bit is equal to 1, the given radio resource belongs to the Q1 radio resource(s).

In one embodiment, the first information in the present disclosure indicating the Q1 radio resource(s) means that a given bit is any of the Q2 bit(s) in the first bitmap, the given bit is used for corresponding to a given radio resource in the Q2 radio resource(s), when the given bit is equal to 1, the given radio resource is one of the Q1 radio resource(s).

In one embodiment, the first information in the present disclosure indicating the Q1 radio resource(s) means that a given bit is any of the Q2 bit(s) in the first bitmap, the given bit is used for corresponding to a given radio resource in the Q2 radio resource(s), when the given bit is equal to 1, the Q1 radio resource(s) comprises (comprise) the given radio resource.

In one embodiment, the first information in the present disclosure indicating the Q1 radio resource(s) means that a given bit is any of the Q2 bit(s) in the first bitmap, the given bit is used for corresponding to a given radio resource in the Q2 radio resource(s), when the given bit is equal to 0, the given radio resource does not belong to the Q1 radio resource(s).

In one embodiment, the first information in the present disclosure indicating the Q1 radio resource(s) means that a given bit is any of the Q2 bit(s) in the first bitmap, the given bit is used for corresponding to a given radio resource in the Q2 radio resource(s), when the given bit is equal to 0, the given radio resource is not one of the Q1 radio resource(s).

In one embodiment, the first information in the present disclosure indicating the Q1 radio resource(s) means that a given bit is any of the Q2 bit(s) in the first bitmap, the given bit is used for corresponding to a given radio resource in the Q2 radio resource(s), when the given bit is equal to 0, the Q1 radio resource(s) does (do) not the given radio resource.

In one embodiment, (an) index(es) of the Q1 radio resource(s) is(are) sequentially radio resource #0, radio resource #1, . . . , and radio resource #(Q1-1).

In one embodiment, the first information in the present disclosure indicating the Q1 radio resource(s) means that the first information comprises (an) index(es) of the Q1 radio resource(s) in the Q2 radio resource(s).

In one embodiment, the first information in the present disclosure indicating the Q1 radio resource(s) means that a given index is an index of any of the Q2 radio resource(s), the given index is used for corresponding to a given radio resource in the Q2 radio resource(s), when the first information comprises the given index, the given radio resource corresponding to the given index belongs to the Q1 radio resource(s).

In one embodiment, the first information in the present disclosure indicating the Q1 radio resource(s) means that a given index is an index of any of the Q2 radio resource(s), the given index is used for corresponding to a given radio resource in the Q2 radio resource(s), when the first information comprises the given index, the given radio resource corresponding to the given index is one of the Q1 radio resource(s).

In one embodiment, the first information in the present disclosure indicating the Q1 radio resource(s) means that a given index is an index of any of the Q2 radio resource(s), the given index is used for corresponding to a given radio resource in the Q2 radio resource(s), when the first information comprises the given index, the Q1 radio resource(s) comprises (comprise) the given radio resource corresponding to the given index.

In one embodiment, the first information in the present disclosure indicating the Q1 radio resource(s) means that a given index is one of the radio resource #0, the radio resource #1, . . . , and the radio resource #(Q1-1), the given index is used for corresponding to a given radio resource in the Q2 radio resource(s), when the first information comprises the given index, the given radio resource corresponding to the given index belongs to the Q1 radio resource(s).

In one embodiment, the first information in the present disclosure indicating the Q1 radio resource(s) means that a given index is one of the radio resource #0, the radio resource #1, . . . , and the radio resource #(Q1-1), the given index is used for corresponding to a given radio resource in the Q2 radio resource(s), when the first information comprises the given index, the given radio resource corresponding to the given index is one of the Q1 radio resource(s).

In one embodiment, the first information in the present disclosure indicating the Q1 radio resource(s) means that a given index is one of the radio resource #0, the radio resource #1, . . . , and the radio resource #(Q1-1), the given index is used for corresponding to a given radio resource in the Q2 radio resource(s), when the first information comprises the given index, the Q1 radio resource(s) comprises (comprise) the given radio resource corresponding to the given index.

In one embodiment, the first information indicates a time-frequency resource position of any of the Q1 radio resource(s).

In one embodiment, the first information comprises Q1 piece(s) of first-type sub-information, and each of the Q1 piece(s) of first-type sub-information respectively corresponds to the Q1 radio resource(s).

In one embodiment, any of the Q1 piece(s) of first-type sub-information indicates a time-frequency resource position of one radio resource corresponding to the Q1 radio resource(s).

In one embodiment, the first information comprises Q1 second-type field(s), each of the Q1 second-type field(s) consists of a positive integer(s); each of the Q1 second-type field(s) respectively corresponds to Q1 radio resource(s).

In one embodiment, any of the Q1 second-type field(s) indicates an index of its corresponding radio resource in the Q1 radio resource(s).

In one embodiment, any of the Q1 second-type field(s) indicates an index of its corresponding one of the Q1 radio resource(s) in the Q1 radio resource(s).

In one embodiment, any of the Q1 second-type field(s) indicates an index of its corresponding one of the Q1 radio resource(s) in the Q2 radio resource(s).

In one embodiment, any of the Q1 second-type field(s) indicates a time-frequency resource position of its corresponding radio resource in the Q1 radio resource(s).

In one embodiment, the first information comprises Q1 second-type field(s), each of the Q1 second-type field(s) consists of a positive integer number of bit(s); at least one of the Q1 second-type field(s) indicates an index of its corresponding one of the Q1 radio resource(s) in the Q1 radio resource(s), Q1 being a positive integer.

In one embodiment, the first information comprises Q2 third-type field(s), each of the Q2 third-type field(s) consists of a positive integer(s); and each of the Q2 third-type field(s) respectively corresponds to Q2 radio resource(s).

In one embodiment, one of the Q2 third-type field(s) indicates an index of one of the Q2 radio resource(s) belonging to the Q1 radio resource(s).

In one embodiment, one of the Q2 third-type field(s) indicates an index of one of the Q2 radio resource(s) belonging to the Q1 radio resource(s) in the Q2 radio resource(s).

In one embodiment, one of the Q2 third-type field(s) indicates a time-frequency resource position of one of the Q2 radio resource(s) belonging to the Q1 radio resource(s).

In one embodiment, a fourth radio resource belongs to the Q2 radio resource(s) and does not belong to the Q1 radio resource(s), one of the Q2 third-type field(s) corresponding to the fourth radio resource is empty.

In one subembodiment of the above embodiment, the third-type field being empty means that each of the positive integer number of bit(s) corresponding to the third field is 0.

In one subembodiment of the above embodiment, the third-type field being empty means that each of the positive integer number of bit(s) corresponding to the third field is 1.

In one embodiment, the first information comprises Q2 third-type field(s), each of the Q2 third-type field(s) consists of a positive integer number of bit(s); Q1 third-type field(s) in the Q2 third-type field(s) respectively indicates the Q1 radio resource(s), Q1 and Q2 being positive integers.

In one embodiment, the first information comprises Q2 third-type field(s), each of the Q2 third-type field(s) consists of a positive integer number of bit(s); at least one of the Q1 third-type field(s) in the Q2 third-type field(s) indicates a corresponding radio resource in the Q1 radio resource(s), Q1 and Q2 being positive integers.

### Embodiment 10

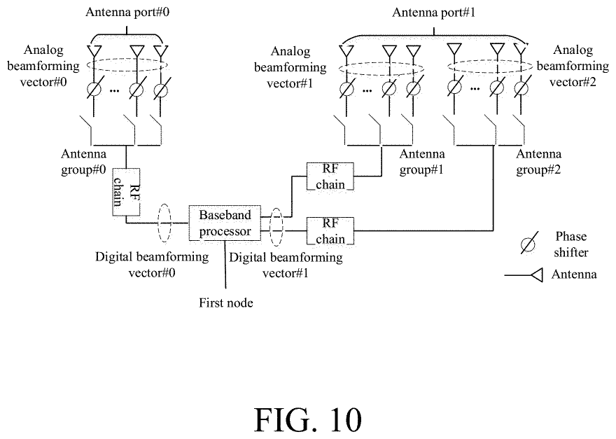

Embodiment 10 illustrates a schematic diagram of a relationship between antenna ports and antenna groups according to one embodiment of the present disclosure, as shown in FIG. 10.

In Embodiment 10, an antenna port group comprises a positive integer number of antenna port(s); an antenna port is formed by superimposing antennas in a positive integer number of antenna group(s) through antenna virtualization; an antenna group comprises a positive integer number of antenna(s). An antenna group is connected to a baseband processor via a Radio Frequency (RF) chain, so different antenna groups correspond to different RF chains. A given antenna port is one antenna port of the one antenna port group, mapping coefficients of all antennas in a positive integer number of antenna group(s) comprised by the given antenna port to the given antenna port constitute a beamforming vector corresponding to the given antenna port. Mapping coefficients of multiple antennas in any given antenna group of a positive integer number of antenna group(s) comprised by the given antenna port to the given antenna port constitute an analog beamforming vector of the given antenna group. Analog beamforming vector(s) respectively corresponding to the positive integer number of antenna group(s) comprised in the given antenna port is(are) arranged diagonally to form an analog beamforming matrix corresponding to the given antenna port. Mapping coefficient(s) from the positive integer number of antenna group(s) comprised in the given antenna port to the given antenna port constitutes (constitute) a digital beamforming vector corresponding to the given antenna port. A beamforming vector corresponding to the given antenna port is acquired as a product of the analog beamforming matrix corresponding to the given antenna port and the digital beamforming vector corresponding to the given antenna port.

FIG. 10 illustrates two antenna ports, namely, antenna port #0 and antenna port #1. Herein, the antenna port #0 consists of antenna group #0, and the antenna port #1 consists of antenna group #1 and antenna group #2. Mapping coefficients of multiple antennas in the antenna group #0 to the antenna port #0 constitute an analog beamforming vector #0, while a mapping coefficient of the antenna group #0 to the antenna port group #0 constitutes a digital beamforming vector #0. A beamforming vector corresponding to the antenna port #0 is acquired as a product of the analog beamforming vector #0 and the digital beamforming vector #0. Mapping coefficients of multiple antennas in the antenna group #1 and of multiple antennas in the antenna group #2 to the antenna port group #1 respectively constitute an analog beamforming vector #1 and an analog beamforming vector #2; and mapping coefficients of the antenna group #1 and the antenna group #2 to the antenna port #1 constitute a digital beamforming vector #1. A beamforming vector corresponding to the antenna port #1 is acquired as a product of an analog beamforming matrix formed by the analog beamforming vector #1 and the analog beamforming vector #2 arranged diagonally and the digital beamforming vector #1.

In one embodiment, an antenna port only comprises one antenna group, i.e., one RF chain, for instance, the antenna port #0 in FIG. 10.

In one subembodiment of the above embodiment, an analog beamforming matrix corresponding to the one antenna port is dimensionally reduced to an analog beamforming vector, and a digital beamforming vector corresponding to the one antenna port is dimensionally reduced to a scaler, a beamforming vector corresponding to the one antenna port is equal to an analog beamforming vector corresponding thereto. For example, the antenna port #0 in FIG. 10 only comprises the antenna group #0, the digital beamforming vector #0 in FIG. 10 is dimensionally reduced to a scaler, a beamforming vector corresponding to the antenna port #0 is the analog beamforming vector #0.

In one embodiment, one antenna port comprises a positive integer number of antenna group(s), that is, a positive integer number of RF chain(s), for example, the antenna port #1 in FIG. 10.

In one embodiment, the specific meaning of the antenna port can be found in 3GPP TS36.211, chapter 5.2 and 6.2, or 3GPP TS38.211, chapter 4.4.

In one embodiment, small-scale channel parameters that a radio signal transmitted on one antenna port goes through can be used to infer small-scale channel parameters that another radio signal transmitted on the antenna port goes through.

In one subembodiment of the above embodiment, the small-scale channel parameters include one or more of a Channel Impulse Response (CIR), a Precoding Matrix Indicator (PMI), a Channel Quality Indicator (CQI), and a Rank Indicator (RI).

In one embodiment, two antennas being Quasi Co-Located (QCL) refers to that all or part of large-scale properties of a radio signal transmitted on one of the two antenna ports can be used to infer all or part of large-scale properties of a radio signal transmitted on the other of the two antenna ports.

In one embodiment, large-scale properties of a radio signal comprise one or more of delay spread, Doppler spread, Doppler shift, average gain, average delay, and spatial Rx parameters.

In one embodiment, the specific meaning of the QCL can be found in 3GPP TS36.211, section 6.2, 3GPP TS38.211, section 4.4 or 3GPP TS38.214, section 5.1.5.

In one embodiment, the phrase that a QCL type between two antenna ports is QCL-TypeD refers to that Spatial Rx parameters of a radio signal transmitted on the one antenna port can be used to infer Spatial Rx parameters of a radio signal transmitted from the other antenna port.

In one embodiment, the phrase that a QCL type between two antenna ports is QCL-TypeD refers to that a radio signal transmitted on the one antenna port and a radio signal transmitted on the other antenna port can be received with same Spatial Rx parameters.

In one embodiment, the specific meaning of the QCL-TypeD can be found in 3GPP TS38.214, section 5.1.5.

In one embodiment, each of the Q1 radio resource(s) respectively corresponds to Q1 antenna port(s), Q1 being a positive integer.

In one embodiment, any of the Q1 radio resource(s) corresponds to one antenna port.

In one embodiment, any of the Q1 radio resource(s) comprises a positive integer number of antenna port(s).

In one embodiment, all of the Q1 radio resource(s) corresponds (correspond) to one antenna port.

### Embodiment 11

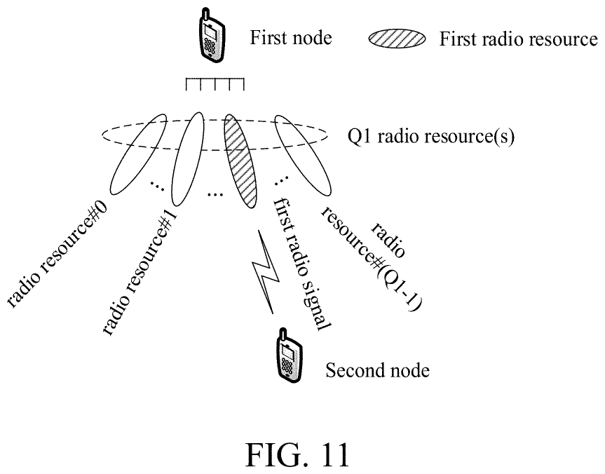

Embodiment 11 illustrates a schematic diagram of Q1 radio resource(s) according to another embodiment of the present disclosure, as shown in FIG. 11. In FIG. 11, (a) solid-framed ellipse(s) represents (represent) Q1 radio resource(s) in the present disclosure; and a slash-filled ellipse represents a first radio resource in the present disclosure.

In Embodiment 11, each of the Q1 radio resource(s) respectively belongs to Q1 spatial parameter group(s) in space domain; the first radio resource belongs to a first spatial parameter group in space domain, and the first spatial parameter group is one of the Q1 spatial parameter group(s); and a first radio signal in the present disclosure uses the first spatial parameter group for its transmission, Q1 being a positive integer.

In one embodiment, any of the Q1 spatial parameter group(s) comprises a positive integer number of spatial parameter(s).

In one embodiment, the first spatial parameter group comprises a positive integer number of spatial parameter(s).

In one embodiment, the first spatial parameter group comprises one spatial parameter.

In one embodiment, a spatial parameter comprises one or more of beam direction, analog beamforming matrix, analog beamforming vector, digital beamforming vector, beamforming vector, and spatial domain filter.

In one embodiment, the spatial parameter comprises Spatial Tx parameters.

In one embodiment, the spatial parameter comprises Spatial Rx parameters.

In one embodiment, the spatial filter comprises Spatial Domain Transmission Filter.

In one embodiment, the spatial filter comprises Spatial Domain Reception Filter.

In one embodiment, any of the Q1 spatial parameter group(s) corresponds to a positive integer number of antenna group(s).

In one embodiment, any of the Q1 spatial parameter group(s) corresponds to Q1 antenna group(s).

In one embodiment, any of the Q1 spatial parameter group(s) corresponds to the one antenna group.

In one embodiment, any of the Q1 spatial parameter group(s) comprises a positive integer number of antenna port(s).

In one embodiment, all of the Q1 spatial parameters correspond to one antenna port.

In one embodiment, each of the Q1 spatial parameter group(s) respectively corresponds to Q1 antenna port group(s).

In one embodiment, the first spatial parameter group comprises a positive integer number of antenna port group(s).

In one embodiment, any of the first spatial parameter group corresponds to one antenna port group.

In one embodiment, the first spatial parameter group comprises one antenna port group.

In one embodiment, any of the first spatial parameter group corresponds to one antenna port.

In one embodiment, the one spatial parameter group corresponds to one antenna port.

In one embodiment, all spatial parameters in the first spatial parameter group correspond to a same antenna port.

In one embodiment, any two of the Q1 radio resources belong to two spatial parameter groups in space domain, and a same time domain resource in time domain.

In one embodiment, any two of the Q1 radio resources belong to two spatial parameter groups in space domain, and a same frequency-domain resource in frequency domain.

In one embodiment, any two of the Q1 radio resources belong to two spatial parameter groups in space domain, and comprise a same time-frequency resource unit in time domain and frequency domain.

In one embodiment, at least two of the Q1 radio resources belong to two spatial parameter groups in space domain, and a same time domain resource in time domain.

In one embodiment, at least two of the Q1 radio resources belong to two spatial parameter groups in space domain, and a same frequency-domain resource in frequency domain.

In one embodiment, at least two of the Q1 radio resources belong to two spatial parameter groups in space domain, and comprise a same time-frequency resource unit in time domain and frequency domain.

In one embodiment, any two of the Q1 radio resources belong to two carriers in frequency domain, and a same spatial parameter group in space domain.

In one embodiment, any two of the Q1 radio resources belong to two BWPs in frequency domain, and a same spatial parameter group in space domain.

In one embodiment, any two of the Q1 radio resources respectively comprise two different time-frequency resource units, and a same spatial parameter group in space domain.

In one embodiment, at least two of the Q1 radio resources belong to two carriers in frequency domain, and a same spatial parameter group in space domain.

In one embodiment, at least two of the Q1 radio resources belong to two BWPs in frequency domain, and a same spatial parameter group in space domain.

In one embodiment, at least two of the Q1 radio resources respectively comprise two different time-frequency resource units, and belong to a same spatial parameter group in space domain.

In one embodiment, the first information is used for indicating the Q1 spatial parameter group(s) to which the Q1 radio resource(s) belongs (belong).

In one embodiment, the first information is used for indicating any of the Q1 spatial parameter group(s).

In one embodiment, the first information comprises Q1 piece(s) of second-type sub-information, and each of the Q1 piece(s) of second-type sub-information respectively corresponds to the Q1 radio resource(s).

In one embodiment, a given piece of second-type sub-information is any of the Q1 piece(s) of second-type sub-information, the given second-type sub-information corresponds to a given radio resource in the Q1 radio resource(s), and the given piece of second-type sub-information is used for indicating a spatial parameter group to which the given radio resource belongs.

### Embodiment 12

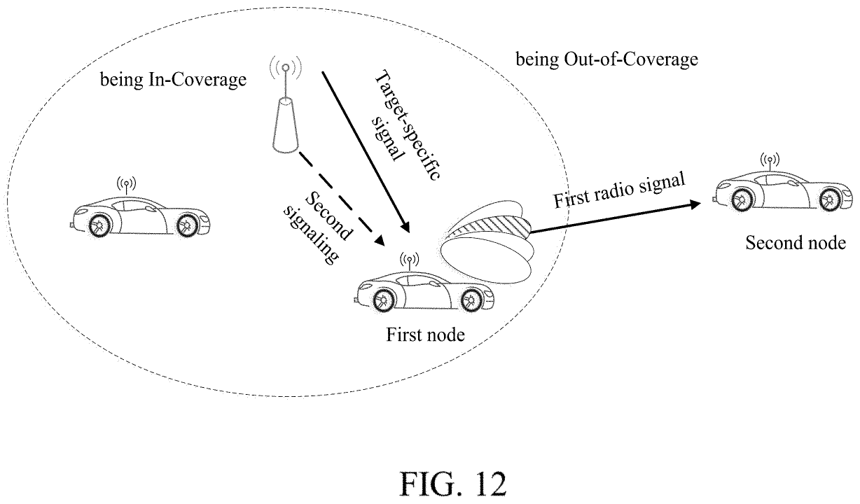

Embodiment 12 illustrates a schematic diagram of a relationship between positions of a first node and a second node according to one embodiment of the present disclosure, as shown in FIG. 12. In FIG. 12, the inside of the dot-framed ellipse represents being in coverage, and the outside of the dot-framed ellipse represents being out of coverage.

In Embodiment 12, the first node in the present disclosure receives a target-specific signal, and judges whether it is in coverage according to target received quality of the target-specific signal.

In Embodiment 12, the first node in the present disclosure is In-coverage, and the second node in the present disclosure is Out-of-Coverage.

In one embodiment, when target received quality of a target-specific signal received by the first node is no less than a target threshold, the first node is In-Coverage.

In one embodiment, when target received quality of a target-specific signal received by the first node is less than a target threshold, the first node is out of coverage.

In one embodiment, when the target received quality of the target-specific signal of at least one cell received by the first node is greater than the target threshold, the first node is in coverage.

In one embodiment, a transmitter of the target-specific signal is a Cell.

In one embodiment, when the target received quality of the target-specific signal of the GNSS received by the first node is greater than the target threshold, the first node is in coverage.

In one embodiment, when the target received quality of the target-specific signal of the GNSS received by the first node is greater than the target threshold, the first node is In-GNSS-Coverage.

In one embodiment, a transmitter of the target-specific signal is the GNSS.

In one embodiment, when the first node does not detect that the target received quality of the target-specific signal of any cell is greater than the target threshold, the first node is not in coverage.

In one embodiment, when the first node does not detect that the target received quality of the target-specific signal of any serving cell is greater than the target threshold, the first node is not in coverage.

In one embodiment, when the first node does not detect that the target received quality of the target-specific signal of one GNSS is greater than the target threshold, the first node is not in coverage.

In one embodiment, when the first node does not detect that the target received quality of the target-specific signal of one GNSS is greater than the target threshold, the first node is Out-of-GNSS-Coverage.

In one embodiment, the target-specific signal comprises the first-type signal in the present disclosure.

In one embodiment, the target-specific signal is transmitted on the first-type channel in the present disclosure.

In one embodiment, the target-specific signal comprises an SS/PBCH block (SSB).

In one embodiment, the target received quality comprises a Reference Signal Received Power (RSRP).

In one embodiment, the target received quality comprises a Sidelink RSRP (S-RSRP).

In one embodiment, the target received quality comprises a Received (linear) average power of the resource elements that carry E-UTRA synchronization signal, measured at the UE antenna connector (SCH_RP).

In one embodiment, the target received quality comprises Reference Signal Received Quality (RSRQ).

In one embodiment, the target received quality comprises a Reference Signal Strength Indicator (RSSI).

In one embodiment, the target received quality comprises a Signal to Noise Ratio (SNR).

In one embodiment, the target received quality comprises a Signal to Interference plus Noise Ratio (SINR).

In one embodiment, the target received quality comprises a Block Error Rate (BLER).

In one embodiment, the target received quality comprises a Bit Error Rate (BER).

In one embodiment, the target received quality comprises a Packet Error Rate (PER).

In one embodiment, the target threshold is measured by dB.

In one embodiment, the target threshold is measured by dBm.

In one embodiment, the target threshold is measured by W.

In one embodiment, the target threshold is measured by mW.

In one embodiment, the target threshold is predefined, that is, no signaling configuration is required.

In one embodiment, the target threshold is configured by a higher-layer signaling.

In one embodiment, the target threshold is configured by system information.

In one embodiment, the target threshold is configured by an SIB.

In one embodiment, the target threshold is configured by an RRC-layer signaling.

In one embodiment, the target threshold is configured by a MAC-layer signaling.

In one embodiment, the target threshold is configured by a PHY-layer signaling.

In one embodiment, the target threshold is configured by DCI.

In one embodiment, first information comprised in a first signaling in the present disclosure explicitly indicates whether the first node is in coverage.

In one embodiment, first information comprised in a first signaling in the present disclosure implicitly indicates whether the first node is in coverage.

In one embodiment, first information in a first signaling in the present disclosure comprises one Field in “MasterInformationBlock-SL” in an IE in 3GPP TS36.331 (v15.0.1).

In one embodiment, first information in a first signaling in the present disclosure comprises one Field in “MasterInformationBlock-V2X-SL” in an IE in 3GPP TS36.331 (v15.0.1).

In one embodiment, first information in a first signaling in the present disclosure comprises “In-Coverage” in “MasterInformationBlock-V2X-SL” in an IE in 3GPP TS36.331 (v15.0.1).

In one embodiment, first information in a first signaling in the present disclosure is a Boolean value; when the first node is in coverage, the first information is TRUE; when the first node is out of coverage, the first information is FALSE.

In one embodiment, a second node in the present disclosure judges whether the first node is in coverage according to the first information.

In one embodiment, when the first node is out of coverage, the first signaling does not comprise the second information; and when the first node is in coverage, the first signaling comprises the second information.

In one embodiment, when the first node is out of coverage, the first signaling does not comprise the second information; and when the first node is in coverage, the first signaling may comprise the second information, and may not comprise the second information.

In one embodiment, when the first information in the first signaling indicates that a transmitter of the first radio signal is out of coverage, received quality of a target-specific signal received by a transmitter of the first radio signal is higher than or equal to a specific threshold; otherwise received quality of the target-specific signal received by a transmitter of the first radio signal is lower the specific threshold.

### Embodiment 13

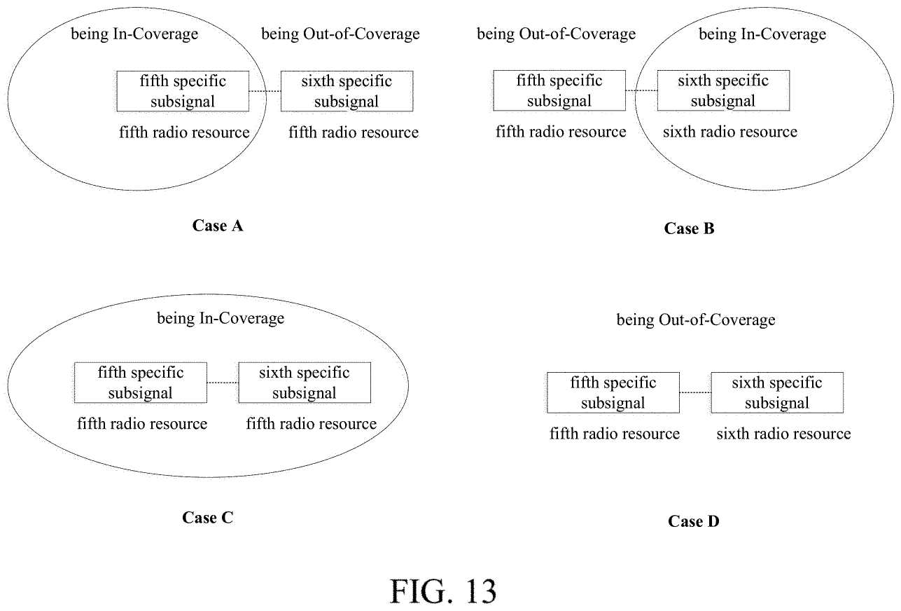

Embodiment 13 illustrates a schematic diagram of a relationship between a fifth radio resource and a sixth radio resource according to one embodiment of the present disclosure, as shown in FIG. 13. In FIG. 13, case A, case B, case C and case D respectively list four coverage relationships of a first node in the present disclosure between a fifth radio resource and a sixth radio resource.

In Embodiment 13, Q1 radio resource(s) in the present disclosure comprises (comprise) the fifth radio resource and the sixth radio resource, the fifth radio resource being different from the sixth radio resource; the target-specific signal in the present disclosure comprises a fifth specific sub-signal and a sixth specific sub-signal; the fifth specific sub-signal is transmitted on a fifth radio resource, and the sixth specific sub-signal is transmitted on a sixth radio resource; in case A, the first node is judged to be in the coverage of the fifth radio resource according to its received the fifth specific sub-signal, and the first node is judged to be out of the coverage of the sixth radio resource according to its received the sixth specific sub-signal; in case B, the first node is judged to be out of the coverage of the fifth radio resource according to its received the fifth specific sub-signal, and the first node is judged to be in the coverage of the sixth radio resource according to its received the sixth specific sub-signal; in case C, the first node is judged to be in the coverage of the fifth radio resource according to its received the fifth specific sub-signal, and the first node is judged to be in the coverage of the sixth radio resource according to its received the sixth specific sub-signal; in case D, the first node is judged to be out of the coverage of the fifth radio resource according to its received the fifth specific sub-signal, and the first node is judged to be out of the coverage of the sixth radio resource according to its received the sixth specific sub-signal.

In one embodiment, the fifth radio resource is different from the sixth radio resource in frequency domain.

In one embodiment, the fifth radio resource is different from the sixth radio resource in time domain.

In one embodiment, the fifth radio resource is different from the sixth radio resource in space domain.

In one embodiment, the space domain refers to the spatial parameters.

In one embodiment, spatial parameters of the fifth radio resource are different from spatial parameters of the sixth radio resource.

In one embodiment, the fifth radio resource is the first radio resource.

In one embodiment, the fifth radio resource is the same with the first radio resource in frequency domain, time domain and space domain.

In one embodiment, the first radio resource is selected out of the Q1 radio resource(s) according to the received quality of the target-specific signal.

In one embodiment, when the target received quality of the fifth specific sub-signal received by the first node on the fifth radio resource is no less than the target threshold, the first node is in coverage on the fifth radio resource.

In one embodiment, when the target received quality of the fifth specific sub-signal received by the first node on the fifth radio resource is less than the target threshold, the first node is out of coverage on the fifth radio resource.

In one embodiment, a transmitter of the fifth specific sub-signal is a Cell.

In one embodiment, a transmitter of the fifth specific sub-signal is the GNSS.

In one embodiment, when the target received quality of the fifth specific sub-signal received by the first node on the fifth radio resource is no less than the target threshold, a transmitter of the fifth specific sub-signal is the GNSS, and the first node is In-GNSS-coverage on the fifth radio resource.

In one embodiment, when the first node does not detect that the target received quality of the fifth specific sub-signal of any cell on the fifth radio resource is greater than the target threshold, the first node is out of coverage on the fifth radio resource.

In one embodiment, when the first node does not detect that the target received quality of the fifth specific sub-signal of any serving cell on the fifth radio resource is greater than the target threshold, the first node is out of coverage on the fifth radio resource.

In one embodiment, when the first node does not detect that the target received quality of the fifth specific sub-signal of one GNSS on the fifth radio resource is greater than the target threshold, the first node is out of coverage on the fifth radio resource.

In one embodiment, when the first node does not detect that the target received quality of the fifth specific sub-signal of one GNSS on the fifth radio resource is greater than the target threshold, the first node is Out-of-GNSS-coverage on the fifth radio resource.

In one embodiment, the fifth specific sub-signal comprises the first-type signal in the present disclosure.

In one embodiment, the fifth specific sub-signal is transmitted on the first-type channel in the present disclosure.

In one embodiment, when the target received quality of the sixth specific sub-signal received by the first node on the sixth radio resource is no less than the target threshold, the first node is in coverage on the sixth radio resource.

In one embodiment, when the target received quality of the sixth specific sub-signal received by the first node on the sixth radio resource is less than the target threshold, the first node is out of coverage on the sixth radio resource.

In one embodiment, a transmitter of the sixth specific sub-signal is a Cell.

In one embodiment, a transmitter of the sixth specific sub-signal is the GNSS.

In one embodiment, when the target received quality of the sixth specific sub-signal received by the first node on the sixth radio resource is no less than the target threshold, a transmitter of the sixth specific sub-signal is the GNSS, and the first node is out of coverage on the sixth radio resource.

In one embodiment, when the first node does not detect that the target received quality of the sixth specific sub-signal of any cell on the sixth radio resource is greater than the target threshold, the first node is out of coverage on the sixth radio resource.

In one embodiment, when the first node does not detect that the target received quality of the sixth specific sub-signal of any serving cell on the sixth radio resource is greater than the target threshold, the first node is out of coverage on the sixth radio resource.

In one embodiment, when the first node does not detect that the target received quality of the sixth specific sub-signal of one GNSS on the sixth radio resource is greater than the target threshold, the first node is out of coverage on the sixth radio resource.

In one embodiment, when the first node does not detect that the target received quality of the sixth specific sub-signal of one GNSS on the sixth radio resource is greater than the target threshold, the first node is Out-of-GNSS-Coverage on the sixth radio resource.

In one embodiment, the sixth specific sub-signal comprises the first-type signal in the present disclosure.

In one embodiment, the sixth specific sub-signal is transmitted on the first-type channel in the present disclosure.

In one embodiment, the first radio resource is selected out of the Q1 radio resource(s) according to the received quality of the target-specific signal.

In one embodiment, the Q1 radio resource(s) is(are) selected out of the Q1 radio resource(s).

In one embodiment, how to select a first radio resource out of the Q1 radio resource(s) is implementation related (that is, there is no need to be standardized).

In one embodiment, how to select the first radio resource out of the Q1 radio resource(s) is determined by the first node itself.

In one embodiment, the first radio resource is selected out of the Q1 radio resource(s) according to the target received quality of the received target-specific signal.

In one embodiment, the target-specific signal is received on the first radio resource, the target-received quality of the target-specific signal is better than the target received quality of a radio signal of any of the Q1 radio resource(s) other than the first radio resource.

In one embodiment, the Q1 radio resource(s) comprises (comprise) Q3 radio resource(s), Q3 being a positive integer no greater than the Q1.

In one subembodiment of the above embodiment, the target received quality of a radio signal received on the Q3 radio resource(s) by the first node is no less than the target threshold.

In one embodiment, the first radio resource is at least one of the Q3 radio resource(s).

In one embodiment, the target-specific signal is received on the first radio resource, the target-received quality of the target-specific signal is better than the target received quality of a radio signal of any of the Q1 radio resource(s) other than the first radio resource.

In one embodiment, the target-specific signal is received on the first radio resource, the target-received quality of the target-specific signal is better than the target received quality of a radio signal of any of the Q3 radio resource(s) other than the first radio resource.

In one embodiment, when the target received quality of the fifth specific sub-signal received by the first node on the fifth radio resource is better than the target received quality of the sixth specific sub-signal received on the sixth radio resource, the sixth radio resource is any of the Q1 radio resource(s), and the fifth radio resource is the first radio resource.

### Embodiment 14

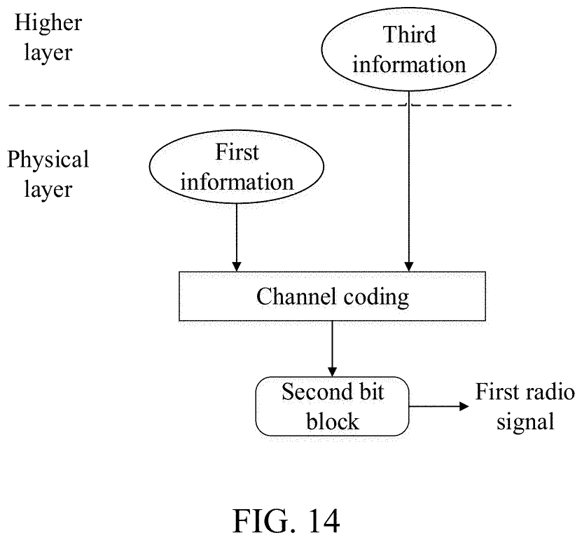

Embodiment 14 illustrates a schematic diagram of relationships among first information, third information, a second bit block and a first radio signal according to one embodiment of the present disclosure, as shown in FIG. 14. In FIG. 14, the ellipses represent information generation and the rectangles represent information processing.

In Embodiment 14, a radio protocol architecture in the present disclosure at least comprises a Physical Layer and a Higher Layer, the higher layer comprises one or more of a MAC sublayer, an RLC sublayer, a PDCP sublayer and an RRC sublayer; a first signaling in the present disclosure comprises the first information and the third information, the first information in the present disclosure is generated by the PHY layer, and the third information in the present disclosure is generated by the higher layer; a second bit block is obtained by performing channel coding on all bits in the first signaling; and the second bit block is used for generating a first radio signal in the present disclosure.

In one embodiment, the first information comprises a first bit string, the first bit string comprising a positive integer number of sequentially-arranged bits.

In one embodiment, the first bit string is generated by the PHY layer.

In one embodiment, the third information comprises one or more fields in an MIB.

In one embodiment, the specific meaning of the MIB can be found in 3GPP TS36.331, section 6.2.2 or 3GPP TS38.331, section 6.2.2.

In one embodiment, the third information comprises one or more fields in an SIB.

In one embodiment, the specific meaning of the SIB can be found in 3GPP TS36.331, section 6.2.2 and section 6.3.1 or 3GPP TS38.331, section 6.2.2 and section 6.3.1.

In one embodiment, the third information comprises one or more fields in a Master Information Block-Sidelink (MIB-SL).

In one embodiment, the specific meaning of the MIB-SL can be found in 3GPP TS36.331, section 6.5.2.

In one embodiment, the third information comprises one or more fields in an MIB-SL-V2X.

In one embodiment, the specific meaning of the MIB-SL-V2X can be found in 3GPP TS36.331, section 6.5.2.

In one embodiment, the third information comprises one or more of timing information and configuration parameters.

In one embodiment, the third information comprises one or more of sl-Bandwidth, direct Frame Number, direct Subframe Number, In-Coverage Indicator, Uplink/Downlink subframe configuration, Uplink/Downlink slot configuration, Slot Format, Subcarrier Spacing, Subcarrier Offset, Demodulation Reference Position, Control Resource Configuration, and Reserved bits.

In one embodiment, the third information comprises a third bit string, the third bit string comprising a positive integer number of sequentially-arranged bits.

In one embodiment, the third bit string is generated by a higher layer.

In one embodiment, the third bit string is generated by an RRC sublayer.

In one embodiment, the third bit string is generated by a MAC sublayer.

In one embodiment, the third bit string is generated by an RRC sublayer, and is transmitted to a PHY layer after being processed by a MAC sublayer.

In one embodiment, the third bit string is generated by an RRC sublayer, and is transmitted to a PHY layer after respectively being processed by a PDCP sublayer, an RLC sublayer, and a MAC sublayer.

In one embodiment, the first signaling comprises a second CB, the second CB comprises a positive integer number of sequentially-arranged bit(s).

In one embodiment, the second CB comprises the first information and the third information.

In one embodiment, the second CB comprises the first bit string and the third bit string.

In one embodiment, the first radio signal is obtained by all or part of bits of the second CB through the first preprocessing in the present disclosure.

In one embodiment, the first radio signal is obtained by all or part of bits of the second CB through the second preprocessing in the present disclosure.

In one embodiment, the first radio signal is an output of all or part of bits of the second CB through the first preprocessing in the present disclosure.

In one embodiment, the first radio signal is an output of all or part of bits of the second CB through the second preprocessing in the present disclosure.

In one embodiment, the second bit block is obtained by all or part of bits of the second CB sequentially through TB-level CRC attachment, CB segmentation, CB-level CRC attachment and channel coding.

In one embodiment, the second bit block is an output of all or part of bits of the second CB sequentially through at least one of TB-level CRC attachment, CB segmentation, CB-level CRC attachment and channel coding.

In one embodiment, the first radio signal is obtained by the second bit block sequentially through rate matching, Code Block Concatenation, scrambling, modulation, layer mapping, antenna port mapping, Mapping to Virtual Resource Blocks, Mapping from Virtual to PRBs, baseband signal generation, and modulation and Upconversion.

In one embodiment, the first radio signal is an output of the second bit block sequentially through rate matching, Code Block Concatenation, scrambling, modulation, layer mapping, antenna port mapping, Mapping to Virtual Resource Blocks, Mapping from Virtual to PRBs, baseband signal generation, and modulation and Upconversion.

In one embodiment, the second bit block is obtained by all or part of bits of the second CB sequentially through TB-level CRC attachment, CB segmentation, CB-level CRC attachment, channel coding and rate matching.

In one embodiment, the second bit block is an output of all or part of bits of the second CB sequentially through at least one of TB-level CRC attachment, CB segmentation, CB-level CRC attachment, channel coding and rate matching.

In one embodiment, the first radio signal is obtained by the second bit block sequentially through Code Block Concatenation, scrambling, modulation, layer mapping, antenna port mapping, Mapping to Virtual Resource Blocks, Mapping from Virtual to PRBs, baseband signal generation, and modulation and Upconversion.

In one embodiment, the first radio signal is an output of the second bit block sequentially through Code Block Concatenation, scrambling, modulation, layer mapping, antenna port mapping, Mapping to Virtual Resource Blocks, Mapping from Virtual to PRBs, baseband signal generation, and modulation and Upconversion.

In one embodiment, the second bit block is obtained by all or part of bits of the second CB sequentially through TB-level CRC attachment, CB segmentation, CB-level CRC attachment, channel coding, rate matching and CB Concatenation.

In one embodiment, the second bit block is an output of all or part of bits of the second CB sequentially subjected to at least one of TB-level CRC attachment, CB segmentation, CB-level CRC attachment, channel coding, rate matching and CB Concatenation.

In one embodiment, the first radio signal is obtained by the second bit block sequentially through scrambling, modulation, layer mapping, antenna port mapping, Mapping to Virtual Resource Blocks, Mapping from Virtual to PRBs, baseband signal generation, and modulation and Upconversion.

In one embodiment, the first radio signal is an output of the second bit block sequentially through scrambling, modulation, layer mapping, antenna port mapping, Mapping to Virtual Resource Blocks, Mapping from Virtual to PRBs, baseband signal generation, and modulation and Upconversion.

In one embodiment, the second Code Block is one CB.

In one embodiment, the second CB is one of CB(s) obtained by a TB sequentially through TB-level CRC attachment, CB Segmentation, and CB-level CRC attachment.

In one embodiment, the second CB is obtained by one TB through TB-level CRC attachment.

In one embodiment, only the second CB is used for generating the first radio signal.

In one embodiment, there exists a CB other than the second CB also being used for generating the first radio signal.

In one embodiment, the first information is used for performing scrambling on the second CB.

In one embodiment, the first information is used for generating a scrambling sequence for scrambling the second CB.

In one embodiment, an initial value of a scrambling sequence for scrambling the second CB is related to the first information.

In one embodiment, the first information is used for generating a TB-level CRC performed on the second CB.

In one embodiment, the first information is used for generating a CB-level CRC performed on the second CB.

In one embodiment, the first information is used for generating a DMRS of the first radio signal.

### Embodiment 15

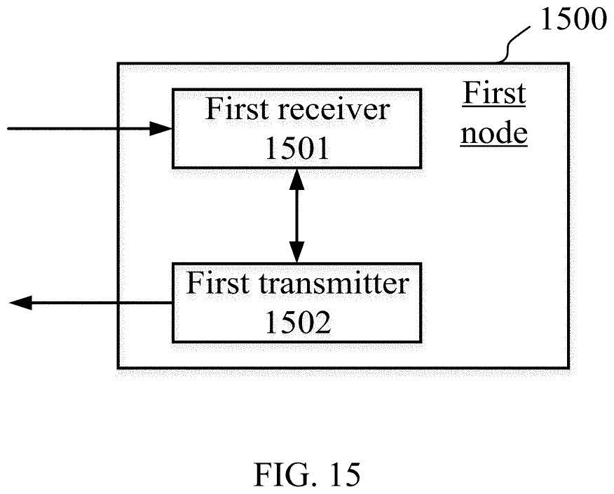

Embodiment 15 illustrates a structure block diagram of a processing device used in a first node, as shown in FIG. 15. In Embodiment 15, a first node processing device 1500 mainly consists of a first receiver 1501 and a first transmitter 1502.

In one embodiment, the first receiver 1501 comprises at least one of an antenna 452, a transmitter/receiver 454, a multi-antenna receiving processor 458, a receiving processor 456, a controller/processor 459, a memory 460 or a data source 467 in FIG. 4 of the present disclosure.

In one embodiment, the first transmitter 1502 comprises at least one of an antenna 452, a transmitter/receiver 454, a multi-antenna transmitting processor 457, a transmitting processor 468, a controller/processor 459, a memory 460, or a data source 467 in FIG. 4 of the present disclosure.

In Embodiment 15, the first transmitter 1502 transmits a first radio signal on a first radio resource; herein, the first radio signal comprises a first signaling, the first signaling comprising first information.

In one embodiment, whether the first signaling comprises second information is related to the first information, and the first information in the first signaling indicates whether the first node is in coverage.

In one embodiment, whether the first signaling comprises second information is related to the first information, the first information in the first signaling indicates Q1 radio resource(s), and the first radio resource is one of the Q1 radio resource(s), Q1 being a positive integer.

In one embodiment, the first information in the first signaling indicates whether the first signaling comprises second information.

In one embodiment, the first receiver 1501 judges whether the first node is in coverage; herein, the first information in the first signaling indicates whether the first node is in coverage; only when the first node is in coverage, the first signaling may comprise the second information.

In one embodiment, the first receiver 1501 receives a second signaling, the second signaling indicates Q2 radio resource(s), Q2 being a positive integer; herein, the Q2 radio resource(s) comprises (comprise) the Q1 radio resource(s); and the first information in the first signaling indicates the Q1 radio resource(s).

In one embodiment, the first transmitter 1502 performs channel coding on all bits in the first signaling to obtain a second bit block; herein, the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

In one embodiment, the first receiver 1501 receives a target-specific signal, and judges whether the first node in coverage according to target received quality of the target-specific signal.

In one embodiment, the second information in the first signaling indicates whether a reception timing of the first radio signal can be used for determining transmission timings of radio signals transmitted on the Q1 radio resources, Q1 being a positive integer greater than 1.

In one embodiment, the first receiver 1501 also receives a second radio signal on a second radio resource; herein, when the second information in the first signaling indicates that a reception timing of the first radio signal can be used for determining transmission timing(s) on the Q1 radio resource(s), a reception timing of the first radio signal is used for determining a transmission timing of the second radio signal, otherwise a transmission timing of the second radio signal is unrelated to a reception timing of a radio signal transmitted by the first node.

In one embodiment, the first node is a UE.

In one embodiment, the first node is a relay node.

### Embodiment 16

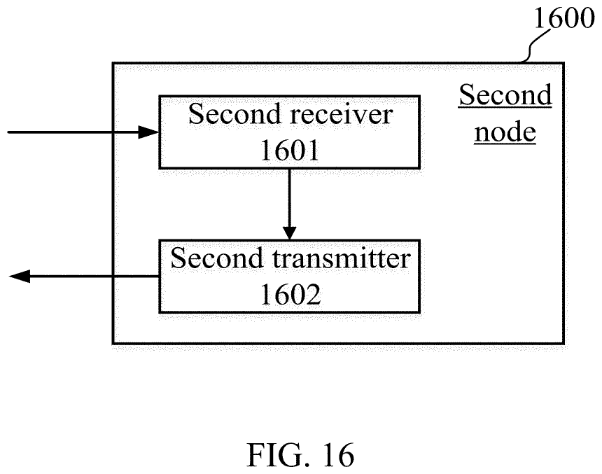

Embodiment 16 illustrates a structure block diagram of a processing device in a second node, as shown in FIG. 16. In FIG. 16, the second node processing device 1600 mainly consists of a second receiver 1601 and a second transmitter 1602.

In one embodiment, the second receiver 1601 comprises at least one of an antenna 420, a transmitter/receiver 418, a multi-antenna receiving processor 472, a receiving processor 470, a controller/processor 475 or a memory 476 in FIG. 4 of the present disclosure.

In one embodiment, the second transmitter 1602 comprises at least one of an antenna 420, a transmitter/receiver 418, a multi-antenna transmitting processor 471, a transmitting processor 416, a controller/processor 475 or a memory 476 in FIG. 4 of the present disclosure.

In Embodiment 16, the second receiver 1601 receives a first radio signal on a first radio resource; the first radio signal comprises a first signaling, the first signaling comprising first information.

In one embodiment, whether the first signaling comprises second information is related to the first information, and the first information in the first signaling indicates whether the first node is in coverage.

In one embodiment, whether the first signaling comprises second information is related to the first information, the first information in the first signaling indicates Q1 radio resource(s), and the first radio resource is one of the Q1 radio resource(s), Q1 being a positive integer.

In one embodiment, the first information in the first signaling indicates whether the first signaling comprises second information.

In one embodiment, the first information in the first signaling indicates whether a transmitter of the first radio signal is in coverage, only when the first information in the first signaling indicates that the transmitter of the first radio signal is in coverage, the first signaling may comprise the second information.

In one embodiment, Q2 radio resource(s) is(are) indicated by a second signaling, Q2 being a positive integer; the Q2 radio resource(s) comprises (comprise) the Q1 radio resource(s); and the Q1 radio resource(s) is(are) indicated by the first information in the first signaling.

In one embodiment, the second receiver 1601 performs channel decoding on a second bit block to obtain all bits in the first signaling; herein, the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

In one embodiment, the second transmitter 1602 determines a transmission timing for transmitting a radio signal on a second radio resource according to the second information in the first signaling; herein, the second radio resource is one of the Q1 radio resources other than the first radio resource, Q1 being greater than 1; the second information in the first signaling indicates whether a reception timing of the first radio signal can be used for determining transmission timings on the Q1 radio resources.

In one embodiment, the second transmitter 1602 transmits a second radio signal on the second radio resource; herein, when the second information in the first signaling indicates that a reception timing of the first radio signal can be used for determining (a) transmission timing(s) for transmitting (a) radio signal(s) on the Q1 radio resource(s), a reception timing of the first radio signal is used for determining a transmission timing of the second radio signal, otherwise a transmission timing of the second radio signal is unrelated to a reception timing of a radio signal transmitted by a transmitter of the first radio signal.

In one embodiment, the second node is a UE.

In one embodiment, the second node is a relay node.

The ordinary skill in the art may understand that all or part steps in the above method may be implemented by instructing related hardware through a program. The program may be stored in a computer readable storage medium, for example Read-Only Memory (ROM), hard disk or compact disc, etc. Optionally, all or part steps in the above embodiments also may be implemented by one or more integrated circuits. Correspondingly, each module unit in the above embodiment may be realized in the form of hardware, or in the form of software function modules. The first node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present disclosure includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present disclosure includes but is not limited to macro-cellular base stations, micro-cellular base stations, home base stations, relay base station, eNB, gNB, Transmitter Receiver Point (TRP), GNSS, relay satellites, satellite base stations, space base stations and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
transmitting a first radio signal on a first radio resource;
wherein the first radio signal comprises a first signaling, the first signaling comprising first information; whether the first signaling comprises second information is related to the first information, and the first information in the first signaling indicates whether the first node is in coverage; or, whether the first signaling comprises second information is related to the first information, the first information in the first signaling indicates Q1 radio resource(s), and the first radio resource is one of the Q1 radio resource(s), Q1 being a positive integer; or, the first information in the first signaling indicates whether the first signaling comprises second information.

2. The method according to claim 1, comprising:
receiving a second signaling, the second signaling indicating Q2 radio resource(s), Q2 being a positive integer;
wherein the Q2 radio resource(s) comprises (comprise) the Q1 radio resource(s);
and the first information in the first signaling indicates the Q1 radio resource(s).

3. The method according to claim 2, comprising:
receiving a target-specific signal, and judging whether the first node is in coverage;
wherein whether the first node is in coverage is judged according to target received quality of the target-specific signal; the first information in the first signaling indicates whether the first node is in coverage; only when the first node is in coverage, the first signaling may comprise the second information; when the first signaling comprises the second information, the second information indicates whether a reception timing of the first radio signal can be used for determining transmission timings for transmitting radio signals on the Q1 radio resources, Q1 being greater than 1;
or,
performing channel coding on all bits in the first signaling to obtain a second bit block;
wherein the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information; when the first signaling comprises the second information, the second information indicates whether a reception timing of the first radio signal can be used for determining transmission timings for transmitting radio signals on the Q1 radio resources, Q1 being greater than 1.

4. The method according to claim 3, comprising:
receiving a second radio signal on the second radio resource;
wherein when the second information in the first signaling indicates that a reception timing of the first radio signal can be used for determining transmission timing(s) on the Q1 radio resource(s), a reception timing of the first radio signal is used for determining a transmission timing of the second radio signal, otherwise a transmission timing of the second radio signal is unrelated to a reception timing of a radio signal transmitted by the first node.

5. A method in a second node for wireless communications, comprising:
receiving a first radio signal on a first radio resource;
wherein the first radio signal comprises a first signaling, the first signaling comprising first information; whether the first signaling comprises second information is related to the first information, and the first information in the first signaling indicates whether the first node is in coverage; or, whether the first signaling comprises second information is related to the first information, the first information in the first signaling indicates Q1 radio resource(s), and the first radio resource is one of the Q1 radio resource(s), Q1 being a positive integer; or, the first information in the first signaling indicates whether the first signaling comprises second information.

6. The method according to claim 5, wherein Q2 radio resource(s) is(are) indicated by a second signaling, Q2 being a positive integer; the Q2 radio resource(s) comprises (comprise) the Q1 radio resource(s); and the first information in the first signaling indicates the Q1 radio resource(s).

7. The method according to claim 6, wherein the first information in the first signaling indicates whether a transmitter of the first radio signal is in coverage, only when the first information in the first signaling indicates that the transmitter of the first radio signal is in coverage, the first signaling may comprise the second information; when the first signaling comprises the second information, the second information in the first signaling indicates whether a reception timing of the first radio signal can be used for determining transmission timings on the Q1 radio resources; wherein the second radio resource is one of the Q1 radio resources other than the first radio resource, Q1 being greater than 1;
or,
performing channel decoding on a second bit block to obtain all bits in the first signaling;
wherein the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information; when the first signaling comprises the second information, the second information in the first signaling indicates whether a reception timing of the first radio signal can be used for determining transmission timings on the Q1 radio resources; the second radio resource is one of the Q1 radio resources other than the first radio resource, Q1 being greater than 1.

8. The method according to claim 7, comprising:
transmitting a second radio signal on the second radio resource;
wherein when the second information in the first signaling indicates that a reception timing of the first radio signal can be used for determining (a) transmission timing(s) for transmitting (a) radio signal(s) on the Q1 radio resource(s), a reception timing of the first radio signal is used for determining a transmission timing of the second radio signal, otherwise a transmission timing of the second radio signal is unrelated to a reception timing of a radio signal transmitted by a transmitter of the first radio signal.

9. A first node for wireless communications, comprising:
a first transmitter: transmitting a first radio signal on a first radio resource;
wherein the first radio signal comprises a first signaling, the first signaling comprising first information; whether the first signaling comprises second information is related to the first information, and the first information in the first signaling indicates whether the first node is in coverage; or, whether the first signaling comprises second information is related to the first information, the first information in the first signaling indicates Q1 radio resource(s), and the first radio resource is one of the Q1 radio resource(s), Q1 being a positive integer; or, the first information in the first signaling indicates whether the first signaling comprises second information.

10. The first node according to claim 9, comprising:
a first receiver, receiving a target-specific signal, and judging whether the first node is in coverage;
wherein whether the first node is in coverage is judged according to target received quality of the target specific signal; the first information in the first signaling indicates whether the first node is in coverage; only when the first node is in coverage, the first signaling may comprise the second information.

11. The first node according to claim 9, comprising:
the first receiver receiving a second signaling, and the second signaling indicating Q2 radio resource(s), Q2 being a positive integer;
wherein the Q2 radio resource(s) comprises (comprise) the Q1 radio resource(s);
and the first information in the first signaling indicates the Q1 radio resource(s).

12. The first node according to claim 9, comprising:
the first transmitter performing channel coding on all bits in the first signaling to obtain a second bit block;
wherein the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

13. The first node according to claim 9, wherein when the first signaling comprises the second information, the second information indicates whether a reception timing of the first radio signal can be used for determining transmission timings for transmitting radio signals on the Q1 radio resources, Q1 being greater than 1.

14. The first node according to claim 13, comprising:
the first receiver receiving a second radio signal on the second radio resource;
wherein when the second information in the first signaling indicates that a reception timing of the first radio signal can be used for determining (a) transmission timing(s) on the Q1 radio resource(s), a reception timing of the first radio signal is used for determining a transmission timing of the second radio signal, otherwise a transmission timing of the second radio signal is unrelated to a reception timing of a radio signal transmitted by the first node.

15. A second node for wireless communications, comprising:
a second receiver: receiving a first radio signal on a first radio resource;
wherein the first radio signal comprises a first signaling, the first signaling comprising first information; whether the first signaling comprises second information is related to the first information, and the first information in the first signaling indicates whether the first node is in coverage; or, whether the first signaling comprises second information is related to the first information, the first information in the first signaling indicates Q1 radio resource(s), and the first radio resource is one of the Q1 radio resource(s), Q1 being a positive integer; or, the first information in the first signaling indicates whether the first signaling comprises second information.

16. The second node according to claim 15, wherein the first information in the first signaling indicates whether a transmitter of the first radio signal is in coverage, only when the first information in the first signaling indicates that the transmitter of the first radio signal is in coverage, the first signaling may comprise the second information.

17. The second node according to claim 15, wherein Q2 radio resource(s) is(are) indicated by a second signaling, Q2 being a positive integer; the Q2 radio resource(s) comprises (comprise) the Q1 radio resource(s); and the first information in the first signaling indicates the Q1 radio resource(s).

18. The second node according to claim 15, comprising:
the second receiver performing channel decoding on a second bit block to obtain all bits in the first signaling;
wherein the second bit block is used for generating the first radio signal; the first information in the first signaling is generated by a physical layer; the first signaling comprises third information, and the third information in the first signaling is generated by a higher layer; the first information in the first signaling indicates whether the first signaling comprises the second information.

19. The second node according to claim 15, comprising:
a second transmitter, determining a transmission timing of a radio signal transmitted on a second radio resource according to the second information in the first signaling;
wherein the second radio resource is one of the Q1 radio resources other than the first radio resource, Q1 being greater than 1; the second information in the first signaling indicates whether a reception timing of the first radio signal can be used for determining transmission timings on the Q1 radio resources.

20. The second node according to claim 19, comprising:
the second transmitter transmitting a second radio signal on the second radio resource;
wherein when the second information in the first signaling indicates that a reception timing of the first radio signal can be used for determining (a) transmission timing(s) for transmitting (a) radio signal(s) on the Q1 radio resource(s), a reception timing of the first radio signal is used for determining a transmission timing of the second radio signal, otherwise a transmission timing of the second radio signal is unrelated to a reception timing of a radio signal transmitted by a transmitter of the first radio signal.
